(19) United States
(12) Patent Application Publication
(10) Pub. No.: US 2025/0343921 A1
(43) Pub. Date: Nov. 6, 2025

(54) ENCODING METHOD, DECODING METHOD, CODE STREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventor: Hang HUANG, Dongguan (CN)

(21) Appl. No.: 19/268,132

(22) Filed: Jul. 14, 2025

Related U.S. Application Data
(63) Continuation of application No. PCT/CN2023/073365, filed on Jan. 20, 2023.

(51) Int. Cl. H04N 19/167; H04N 19/124; H04N 19/176; H04N 19/70

(52) U.S. Cl. CPC H04N 19/167; H04N 19/124; H04N 19/176; H04N 19/70

(57) ABSTRACT

The embodiments of the present disclosure disclose a decoding method, which includes: parsing a bitstream to determine first syntax element information of a current block; determining a coefficient region where to-be-decoded coefficients of the current block are located based on an end of block of the current block indicated by the first syntax element information; where the coefficient region includes one or more coefficient regions, and scanning orders of respective coefficient regions are continuous; determining second syntax element information of the coefficient region; where the second syntax element information indicates whether coefficient decoding is required to be performed on the coefficient region; and determining a quantization coefficient value of the current block based on the second syntax element information.

### CROSS-REFERENCE TO RELATED APPLICATION

This application is a Continuation Application of International Application No. PCT/CN2023/073365 filed on Jan. 20, 2023, which is incorporated herein by reference in its entirety.

### TECHNICAL FIELD

Embodiments of the present disclosure relate to the field of video coding technology, and in particular, to an encoding method, a decoding method, a bitstream, an encoder, a decoder, and a storage medium.

### RELATED ART

With the improvement of people's requirements for video display quality, more and more attention has been paid to computer vision-related fields. In recent years, picture processing technology has been successfully applied across various industries. Regarding a coding process of a video picture, at an encoding side, picture data to be encoded is transformed and quantized, and then transformed and quantized picture data is compressed and encoded via an entropy coding unit, and a bitstream generated after entropy coding will be transmitted to a decoding side; the decoding side parses the bitstream, and after the parsed bitstream is inversely quantized and transformed, the original input picture data may be restored. For a quantization coefficient of a transform block obtained by transformation and quantization processing, the quantization coefficient after transformation and quantization is scanned in a specific scanning order, to entropy code the coefficient (quantization coefficient) related information. Usually, each transform block is divided into different coefficient groups for processing.

However, in a video compression reference software of AOM (AVM, AOMedia Video Model), for a quantization coefficient obtained by transform and quantization processing of a transform block, the quantization coefficient after transformation and quantization is scanned in a specific scanning order, and in this case, numerous consecutive 0 coefficients frequently occur. This situation leads to significant coding overload for individual coefficients, resulting in problems of too large bitrate and poor coding performance.

### SUMMARY

The embodiments of the present disclosure provide an encoding method, a decoding method, a bitstream, an encoder, a decoder and a storage medium.

In a first aspect, the embodiments of the present disclosure provide a decoding method, applied to a decoder, where the method includes:
parsing a bitstream to determine first syntax element information of a current block;
determining a coefficient region where to-be-decoded coefficients of the current block are located based on an end of block of the current block indicated by the first syntax element;
where the coefficient region includes one or more coefficient regions, and scanning orders of respective coefficient regions are continuous;
determining second syntax element information of the coefficient region; where the second syntax element information indicates whether coefficient decoding is required to be performed on the coefficient region; and
determining a quantization coefficient value of the current block based on the second syntax element information.

In a second aspect, the embodiments of the present disclosure provide an encoding method, applied to an encoder, where the method includes:
partitioning a current block according to a scanning order of the current block, to determine at least one coefficient region; where each coefficient region corresponds to multiple to-be-encoded coefficients, and scanning order indexes corresponding to to-be-encoded coefficients in respective coefficient regions are continuous;
determining pieces of second syntax element information of the respective coefficient regions; and
performing entropy coding on a quantization coefficient of at least one coefficient region based on the pieces of second syntax element information of the respective coefficient regions, to write encoded quantization coefficient into a bitstream.

In a third aspect, the embodiments of the present disclosure provide a bitstream, where the bitstream is generated by bit encoding according to to-be-encoded information; where the to-be-encoded information includes at least one of:
first syntax element information, second syntax element information or encoding information of a quantization coefficient of a current block;
where the first syntax element information is used for indicating an end of block of the current block, and the second syntax element information is used for indicating whether coefficient coding is required to be performed on a coefficient region at a region level of a block.

In a fourth aspect, the embodiments of the present disclosure provide a decoder, where the decoder includes: a decoding portion and a first determining portion;
the decoding portion is configured to parse a bitstream to determine first syntax element information of a current block; and
the first determining portion is configured to determine a coefficient region where to-be-decoded coefficients of the current block are located based on an end of block of the current block indicated by the first syntax element; where the coefficient region includes one or more coefficient regions, and scanning orders of respective coefficient regions are continuous; and determine second syntax element information of the coefficient region; where the second syntax element information indicates whether coefficient decoding is required to be performed on the coefficient region;
the decoding portion or the first determining portion is configured to determine a quantization coefficient value of the current block based on the second syntax element information.

In a fifth aspect, the embodiments of the present disclosure provide a decoder, and the decoder includes: a first memory and a first processor; where
the first memory is configured to store a computer program executable on the first processor; and
the first processor is configured to perform the method described in the first aspect upon running the computer program.

In a sixth aspect, the embodiments of the present disclosure provide an encoder, and the encoder includes: a second determining portion and an encoding portion;
the second determining portion is configured to partition a current block according to a scanning order of the current block, to determine at least one coefficient region; where each coefficient region corresponds to multiple to-be-encoded coefficients, and scanning order indexes corresponding to to-be-encoded coefficients in respective coefficient regions are continuous; and determine pieces of second syntax element information of the respective coefficient regions; where the second syntax element information indicates whether coefficient coding is required to be performed on the coefficient region; and
the encoding portion is configured to perform entropy coding on a quantization coefficient of at least one coefficient region based on the second syntax element information of the respective coefficient regions, to write encoded quantization coefficient into a bitstream.

In a seventh aspect, the embodiments of the present disclosure provide an encoder, and the encoder includes: a second memory and a second processor; where
the second memory is configured to store a computer program executable on the second processor; and
the second processor is configured to perform the method described in the second aspect upon running the computer program.

In an eighth aspect, the embodiments of the present disclosure provide a non-transitory computer storage medium, the non-transitory computer storage medium stores a computer program, where when the computer program is executed by a first processor, the decoding method described in the first aspect is implemented, or when the computer program is executed by a second processor, the encoding method described in the second aspect is implemented.

### BRIEF DESCRIPTION OF THE DRAWINGS

FIG. 1 is a schematic diagram of a block-based coding framework.

FIG. 2A is a schematic diagram of an 8×8 diagonal scan.

FIG. 2B is a schematic system composition block diagram of an encoder provided by embodiments of the present disclosure.

FIG. 2C is a schematic system composition block diagram of a decoder provided by embodiments of the present disclosure.

FIG. 3 is a schematic flowchart of a decoding method provided by embodiments of the present disclosure.

FIG. 4 is a first schematic diagram of an exemplary region division of a transform block provided by embodiments of the present disclosure.

FIG. 5 is a second schematic diagram of an exemplary region division of a transform block provided by embodiments of the present disclosure.

FIG. 6 is a schematic diagram of an exemplary 8×8 reverse zig-zag scan provided by embodiments of the present disclosure.

FIG. 7 is a schematic flowchart of an encoding method provided by embodiments of the present disclosure.

FIG. 8 is a schematic diagram of a composition structure of a decoder provided by embodiments of the present disclosure.

FIG. 9 is a schematic diagram of an exemplary hardware structure of a decoder provided by embodiments of the present disclosure.

FIG. 10 is a schematic diagram of a composition structure of an encoder provided by embodiments of the present disclosure.

FIG. 11 is a schematic diagram of an exemplary hardware structure of an encoder provided by embodiments of the present disclosure.

### DETAILED DESCRIPTION

In order to be able to understand the characteristics and technical contents of the embodiments of the present disclosure in more detail, implementations of the embodiments of the present disclosure will be described in detail below in conjunction with the accompanying drawings. The accompanying drawings are for illustrative purposes only and are not intended to limit the embodiments of the present disclosure.

Unless defined otherwise, all technical and scientific terms used here have the same meaning as commonly understood by those skilled in the art to which this application belongs. The terms used here are only for a purpose of describing the embodiments of the present disclosure and are not intended to limit the present disclosure.

In the following description, reference is made to “some embodiments”, which describe a subset of all possible embodiments, but it may be understood that “some embodiments” may be the same subset or different subsets of all possible embodiments and may be combined with each other without conflict. It should also be pointed out that the expressions “first\second\third” involved in the embodiments of the present disclosure are only used for distinguishing similar objects and do not indicate a specific order of the objects. It may be understood that “first\second\third” may be interchanged in a specific order or sequence where permitted, such that the embodiments of the present disclosure described here may be implemented in an order other than those illustrated or described herein.

Before providing further detailed description of the embodiments of the present disclosure, nouns and terms involved in the embodiments of the present disclosure are described first. The nouns and terms involved in the embodiments of the present disclosure are subject to the following interpretations:
a new-generation video coding standard H.266/versatile video coding (VVC);
a coding unit (CU);
a coding tree unit (CTU);
a largest coding unit (LCU);
a prediction unit (PU);
a transform unit (TU);
a transform block (TB);
a discrete cosine transform (DCT);
an alliance for open media (AOM);
an AOMedia video model (AVM);
a rate-distortion optimization quantization (RDOQ); and
a sign data hiding (SDH).

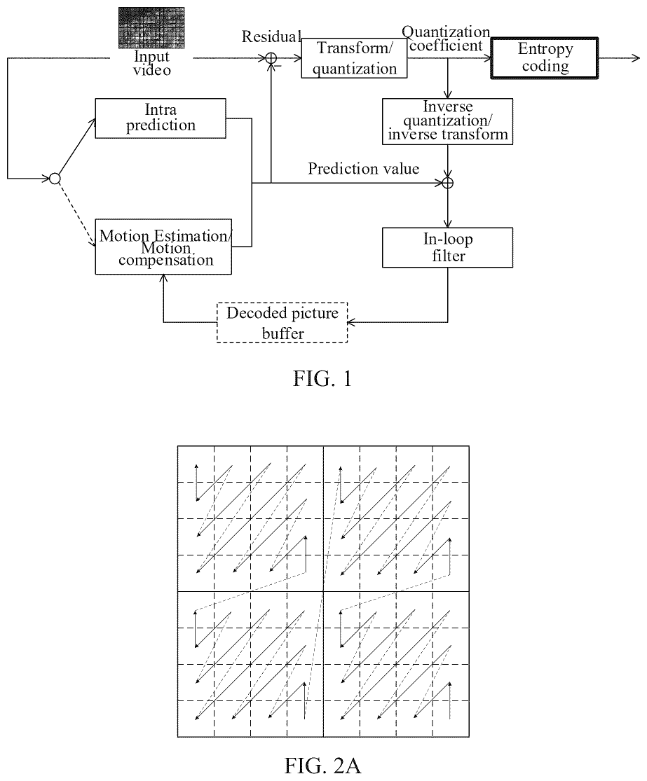

Currently, common video coding standards (such as VVC) all adopt a block-based hybrid coding framework. Each frame in the video picture is divided into square LCUs of the same size (such as 128×128, 64×64). Each LCU may be divided into rectangular CUs according to rules; and the CU may be further divided into smaller PUs, TUs, etc. For example, as shown in FIG. 1, the coding framework may include steps such as a prediction, a transform, a quantization, an entropy coding, and an in-loop filtering. The prediction may further be divided into an intra prediction and an inter prediction, where the inter prediction may include motion estimation and motion compensation. Due to a strong correlation between adjacent samples in a frame of a video picture, the usage of intra prediction in video coding technology may eliminate spatial redundancy between adjacent samples; however, since adjacent frames in a video picture also exhibit a strong similarity, the usage of inter prediction in video coding technology eliminates temporal redundancy between adjacent frames, thereby improving coding efficiency.

During the video coding process, the basic procedure is as follows: at an encoder, a frame of picture is divided into blocks, and for the current block, intra prediction or inter prediction is used to generate a prediction block of the current block, the original block of the current block is subtracted from the prediction block to obtain a residual block, the residual block is transformed and quantized to obtain a quantization coefficient matrix, and the quantization coefficient matrix is entropy coded and output to the bitstream. At a decoder, intra prediction or inter prediction is used to generate a prediction block of the current block. On the other hand, a bitstream is decoded to obtain a quantization coefficient matrix, and the quantization coefficient matrix is inversely quantized and inversely transformed to obtain a residual block. The prediction block and the residual block are added to obtain a reconstructed block. Reconstructed blocks constitute a reconstructed picture, and the in-loop filtering is performed on reconstructed picture based on the picture or on the block, to obtain a decoded picture. The encoder also requires to perform similar operations as the decoder to obtain the decoded picture. The decoded picture may be used as a reference frame for inter prediction for subsequent frames. Block partitioning information, parameter information, or mode information such as prediction, transform, quantization, entropy coding, in-loop filtering, etc., determined by the encoder, need to be output to the bitstream if necessary. The decoder determines the same block partitioning information, parameter information, or mode information such as prediction, transform, quantization, entropy coding, in-loop filtering, etc. as those of the encoder by parsing the bitstream and performing analysis according to existing information, thereby ensuring that the decoded picture obtained by the encoder is the same as the decoded picture obtained by the decoder. The decoded picture obtained by the encoder is often also called the reconstructed picture. During prediction, the current block may be divided into prediction units, while during transformation, the current block may be divided into transform units. The partition of the prediction units and the transform units may be different. The above is the basic procedure of the video encoder and decoder under the block-based hybrid coding framework. With the development of technology, some modules or steps of the framework or procedure may be optimized. The embodiments of the present disclosure are applicable to the basic procedure under the block-based hybrid coding framework, but are not limited to this framework and procedure.

In the embodiments of the present disclosure, the current block may be a current coding unit (CU), a current prediction unit (PU), or a current transform block (TU or TB), etc., which is not limited the embodiments of the present disclosure.

A usage of the traditional coding framework is not limited in the embodiments of the present disclosure. Improvements are primarily made in transform/quantization and inverse quantization/inverse transform parts in the embodiments of the present disclosure, to improve the coding performance of AVM.

The quantization and inverse quantization parts are closely related to the coefficient coding portion. The purpose of quantization is to reduce a dynamic range of the transform coefficients, thereby reducing a number of bits consumed upon coding the coefficients. In a possible implementation, the process of quantization and inverse quantization is as follows:

$${q}_{i} = round ( \frac{{t}_{i}}{qstep} ) \qquad ( 1 )$$

$${t}_{i}^{′} = {q}_{i} \cdot qstep \qquad ( 2 )$$

where tᵢ is a transform coefficient, qstep is a quantization step size (which is related to a quantization parameter set in the configuration file), qᵢ is a quantization coefficient, round( ) is a rounding process, which is not limited to rounding up or rounding down, etc. The process of quantization is controlled by the encoder.

$${t}_{i}^{′}$$

is a reconstructed transform coefficient, and

$${t}_{i}^{′}$$

is different from tᵢ, due to the loss of accuracy caused by the rounding process.

It should be noted that quantization will reduce the accuracy of the transform coefficient, and the loss of accuracy is irreversible. Encoders usually measure the cost of quantization via a rate-distortion cost function. The rate-distortion cost function is as follows:

$$J = D + λ \cdot R = {( {t}_{i} - {t}_{i}^{′} )}^{2} + λ B ( {q}_{i} ) \qquad ( 3 )$$

where B(qᵢ) is a calculation process by which the encoder estimates the bits consumed by encoding qᵢ; J is a rate-distortion cost; λ is a preset coefficient; D is a loss value in the encoding process.

In the embodiments of the present disclosure, no matter how the encoder determines a value of qᵢ, inverse quantization process at the decoding side is unchanged, so the encoder may decide qᵢ more freely. Usually, the encoder will optimize each qᵢ according to a principle of minimizing the total cost of the current block. This process is called rate-distortion quantization, which is also widely used in video coding.

In a possible embodiment, for coefficient coding in AVM, the quantization coefficients may be encoded or decoded by using a manner of multi-symbol arithmetic coding in AVM, each quantization coefficient may be indicated by one or more multi-symbol flags, and, exemplarily, may be indicated by the following multi-symbol flags in segments, according to a size of the quantization coefficient.

Flag 1: indicates the portion (range) of 0-3 with 4 symbols (0, 1, 2, 3), in a case where the symbol of flag 1 is 3, flag 2 needs to be further encoded/decoded.

Flag 2: indicates the portion (range) of 3-6 with 4 symbols (0, 1, 2, 3), in a case where the symbol of flag 2 is 3, flag 3 needs to be further encoded/decoded.

Flag 3: indicates the portion (range) of 6-9 with 4 symbols (0, 1, 2, 3), in a case where the symbol of flag 3 is 3, flag 4 needs to be further encoded/decoded.

Flag 4: indicates the portion (range) of 9-12 with 4 symbols (0, 1, 2, 3), in a case where the symbol of flag 4 is 3, flag 5 needs to be further encoded/decoded.

Flag 5: indicates the portion (range) of 12-15 with 4 symbols (0, 1, 2, 3), in a case where the symbol of flag 5 is 3, the portion (range) greater than or equal to 15 needs to be further encoded/decoded.

It should be noted that in the embodiments of the present disclosure, the portion greater than or equal to 15 uses a bypass model, such as exponential Golomb encoding or decoding; and flags 1 to 5 use a context model, where flag 1 has a separate context model, and flags 2 to 5 share a common context model. In addition, if the current quantization coefficient is a non-zero coefficient, a sign of the current coefficient needs to be encoded/decoded. The encoding/decoding process of each flag of the current block is divided into the following two loops.

Loop 1: first, flags 1-5 are encoded/decoded in a scanning order from a last non-zero coefficient to an upper left corner of the current block.

In the embodiments of the present disclosure, a coefficient portion (coefficient range) indicated by flag 1 is called base range (BR), a coefficient portion indicated by flags 2 to 5 is called lower range (LR), and the portion greater than or equal to 15 is called higher range (HR). The absolute value of a sum of the flags 1 to 5 of the quantization coefficient index qIdx obtained by decoding may also be written as shown in the following formula (4):

$$qIdx = \sum ( BR + \sum LR ) \qquad ( 4 )$$

herein, since LR includes 4 flags, i.e., flags 2 to 5, ΣLR is used to indicate the summing flags 2 to 5.

It should be noted that in a case where parity hiding technology is not introduced, an absolute value level of the quantization coefficient is equal to qIdx.

Loop 2: then, the sign of the non-zero coefficient and the portion of the non-zero coefficient exceeding 15 are encoded/decoded, in an order from the upper left corner of the current block to the last non-zero coefficient. If the coefficient at the upper left corner is non-zero, the sign of the non-zero coefficient is encoded/decoded by using the context model and non-zero coefficients at other positions are encoded/decoded by using the bypass model (also called “equal probability model”).

In an implementation, the syntax table for the coefficient coding in AVM is described as shown in Table 1.

TABLE 1

| | |
|---|---|
| for(c=eob−1;c>=0;c−−){ | |
| pos=scan[c] | |
| if(c==(eob−1)){ | |
| coeff_base_eob | S( ) |
| level=coeff_base_eob+1 | |
| }else{ | |
| coeff_base | S( ) |
| level=coeff_base | |
| } | |
| if(level>NUM_BASE_LEVELS){ | |
| for(idx=0; | |
| idx<COEFF_BASE_RANGE/(BR_CDF_SIZE−1); | |
| idx++){ | |
| coeff_br | S( ) |
| level+=coeff_br | |
| if(coeff_br<(BR_CDF_SIZE−1)) | |
| break | |
| } | |
| } | |
| Quant[pos]=level | |
| } | |
| for(c=0;c<eob;c++){ | |
| pos=scan[c] | |
| if(Quant[pos]!=0){ | |
| if(c==0){ | |
| dc_sign | S( ) |
| sign=dc_sign | |
| }else{ | |
| sign_bit | L(1) |
| sign=sign_bit | |
| } | |
| }else{ | |
| sign=0 | |
| } | |
| if(Quant[pos]> | |
| (NUM_BASE_LEVELS+COEFF_BASE_RANGE)){ | |
| length=0 | |
| do{ | |
| length++ | |
| golomb_length_bit | L(1) |
| }while(!golomb_length_bit) | |
| x=1 | |
| for(i=length−2;i>=0;i−−){ | |
| golomb_data_bit | L(1) |
| x=(x<<1)\|golomb_data_bit | |
| } | |
| Quant[pos]=x+COEFF_BASE_RANGE+NUM_BASE_LEVELS | |
| } | |
| if(pos==0&&Quant[pos]>0){ | |
| dcCategory=sign?1:2 | |
| } | |
| Quant[pos]=Quant[pos]&0xFFFFF | |
| culLevel+=Quant[pos] | |
| if(sign) | |
| Quant[pos]=−Quant[pos] | |
| } | |

In Table 1, S( ) is multi-symbol context model encoding/decoding, and L(1) is bypass model encoding/decoding.

It should be noted that digital video compression technology is mainly used to compress huge digital picture video data for ease of transmission and storage. With the surge in Internet videos and people's increasing demand for video clarity, although existing digital video compression standards may save a lot of video data, there is still a need to pursue better digital video compression technology to reduce a bandwidth and traffic pressure of digital video transmission.

Video compression includes multiple modules such as intra prediction (spatial domain) and/or inter prediction (temporal domain) for reducing or removing inherent redundancy in video, transform/quantization and inverse quantization/inverse transform for residual information, and in-loop filtering and entropy coding for improving the quality of subjective and objective reconstruction. Most mainstream video compression standards describe block-based compression techniques. A video slice, a frame of picture or a series of pictures is divided into basic units of CTU, which is further divided into blocks of CU based on the above divided basic units of CTU. Intra blocks are predicted by using the samples surrounding the block as references, while inter blocks refer to spatially adjacent block information and reference information in other frames. Compared with the prediction signal, the residual information is transformed, quantized and entropy coded into a bitstream in a unit of block. These techniques are described in standards and implemented in various fields related to video compression.

In video coding, the residual information needs to be processed by variable quantization, etc., and then encoded into the bitstream via entropy coding. After the residual is transformed, the transform coefficient may be obtained, and the transform coefficient may be quantized to obtain a quantization coefficient. The coefficient to be coded is collectively referred to as a coefficient. Coefficient entropy coding refers to entropy coding the related information of coefficient after transform quantization according to a specific scanning order.

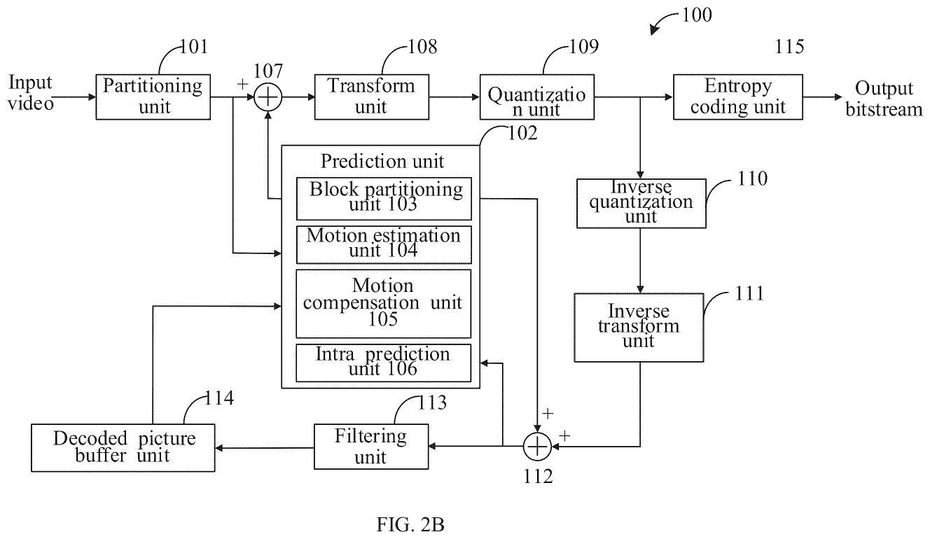

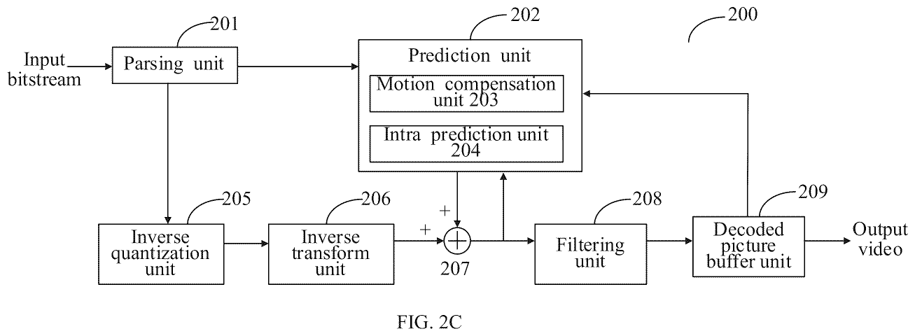

In the video coding standard (e.g., VVC), each transform block may be divided into multiple non-overlapping coefficient groups (CGs) in a unit of CGs having a size of 4×4. A common coefficient scanning manner is shown in a schematic diagram of 8×8 diagonal scan shown in FIG. 2A.

For each CG, there is a flag sb_coded_flag used to indicate whether the current CG needs to be decoded. If the sb_coded_flag is 1, the values of all coefficients in the current CG are decoded from the bitstream. If the sb_coded_flag is 0, it indicates that all coefficients in the current CG are 0. In this case, for both the DC coefficient and the coefficient group (CG) containing the last non-zero coefficient, the flag value defaults to 1.

In the AV2 standard that is being developed, coefficient entropy coding is still performed in a unit of a transform block. However, in the existing coefficient entropy coding related scheme of AV2, when coefficient entropy coding is performed in a unit of a transform block, there is a case where a large number of continuous coefficients are 0 in the scanning order, and the existing art cannot effectively cope with this situation.

Based on this, it is proposed to divide the coefficient block into multiple coefficient regions according to the coefficient scanning order in AVM, and set a flag for each coefficient region to indicate whether the coefficients in the current region need to be encoded and decoded to guide coding.

The embodiments of the present disclosure provide a decoding method and an encoding method. At an encoding side or a decoding side, the quantization coefficient values of the current block are coded by determining second syntax element information, whether to perform the coding process on the coefficients of the current block is controlled effectively by a high-level syntax (i.e., second syntax element information) about whether the coefficient region in which the coefficients are located is coded. And since there may be a large number of continuous zero coefficients in the coefficients after transform quantization, in a case where there are all zero coefficients in the coefficient region, the region coding flag is used to indicate (i.e., the second syntax element information), so that code word consumption may be saved, the bitrate of coding may be reduced, and further, the coding efficiency and performance may be improved.

The following will provide a clear and complete description of the various embodiments of the present disclosure in conjunction with the accompanying drawings.

Exemplarily, referring to FIG. 2B, a schematic diagram of a system composition block diagram of an encoder provided by the embodiments of the present disclosure is illustrated. As shown in FIG. 2B, the encoder 100 may include: a partition unit 101, a prediction unit 102, a first adder 107, a transform unit 108, a quantization unit 109, an inverse quantization unit 110, an inverse transform unit 111, a second adder 112, a filtering unit 113, a decoded picture buffer (DPB) unit 114 and an entropy coding unit 115. An input of the encoder 100 may be a video consisting of a series of pictures or a static picture, and an output of the encoder 100 may be a bitstream (also referred to as a “code stream”) for representing a compressed version of the input video.

The partition unit 101 partitions a picture in the input video into one or more coding tree units (CTUs). The partition unit 101 partitions the picture into a plurality of tiles, and may further partition a tile into one or more bricks. A tile or a brick may include one or more complete and/or partial CTUs. In addition, the partition unit 101 may form one or more slices, where a slice may include one or more tiles arranged in a grid order in the picture, or one or more tiles covering a rectangular region in the picture. The partition unit 101 may further form one or more sub-pictures, where a sub-picture may include one or more slices, tiles or bricks.

During the encoding process of the encoder 100, the partition unit 101 transmits a CTU to the prediction unit 102. Generally, the prediction unit 102 may be composed of a block partition unit 103, a motion estimation (ME) unit 104, a motion compensation (MC) unit 105, and an intra prediction unit 106. In some implementation, the block partition unit 103 iteratively uses quadtree partitioning, binary tree partitioning, and ternary tree partitioning, to further partition the input CTU into smaller coding units (CUs). The prediction unit 102 may use the ME unit 104 and the MC unit 105 to obtain inter prediction blocks of the CUs. The intra prediction unit 106 may use various intra prediction modes to obtain intra prediction blocks of the CUs. In an example, a rate-distortion optimized motion estimation mode may be invoked by the ME unit 104 and the MC unit 105 to acquire an inter prediction block, and a rate-distortion optimized mode determining manner may be invoked by the intra prediction unit 106 to acquire an intra prediction block.

In the embodiments of the present disclosure, the prediction unit 102 outputs the prediction block of the CU, and the first adder 107 calculates a difference between the prediction block of the CU and the CU of the output of the partition unit 101, i.e., a residual CU. The transform unit 108 reads the residual CU and performs one or more transform operations on the residual CU to obtain coefficients. The quantization unit 109 performs quantization on the coefficients and outputs quantization coefficients (i.e., levels). The inverse quantization unit 110 performs a scaling operation on the quantization coefficients to output reconstructed coefficients. The inverse transform unit 111 performs one or more inverse transforms corresponding to the transform in the transform unit 108 and outputs a reconstructed residual. The second adder 112 calculates a reconstructed CU by adding the reconstructed residual and the prediction block of the CU from the prediction unit 102. The second adder 112 further outputs the reconstructed CU to the prediction unit 102 for intra prediction reference. After all CUs in a picture or a sub-picture are reconstructed, the filtering unit 113 performs in-loop filtering on the reconstructed picture or reconstructed sub-picture. The filtering unit 113 includes one or more filters, such as a deblocking filter, a sample adaptive offset (SAO) filter, a neural network-based filter, or the like. Alternatively, in a case where the filtering unit 113 determines that a CU is not used as a reference for encoding other CUs, the filtering unit 113 performs in-loop filtering on one or more target samples in the CU.

The output of the filtering unit 113 is a decoded picture or sub-picture, which is buffered in the DPB unit 114. The DPB unit 114 outputs a decoded picture or sub-picture according to the timing and control information. The picture stored in the DPB unit 114 may also be used as a reference for the prediction unit 102 to perform inter prediction or intra prediction. Finally, the entropy coding unit 115 converts parameters necessary for decoding the picture from the encoder 100 (such as control parameters and supplementary information) into binary form, and encodes such binary form into the bitstream according to the syntax structure of each data unit, that is, the encoder 100 finally outputs the bitstream.

Further, the encoder 100 may include a second processor and a second memory recording a computer program. When the second processor reads and runs the computer program, the encoder 100 reads the input video and generates a corresponding bitstream. Additionally, the encoder 100 may also be a computing device with one or more chips. These units implemented as integrated circuits on a chip have similar connections and data exchange functions as the corresponding units in FIG. 2B.

Referring to FIG. 2C, a schematic diagram of a system composition block diagram of a decoder provided by the embodiments of the present disclosure is illustrated. As shown in FIG. 2C, the decoder 200 may include: a parsing unit 201, a prediction unit 202, an inverse quantization unit 205, an inverse transform unit 206, an adder 207, a filtering unit 208 and a decoded picture buffer unit 209. The input of the decoder 200 is a bitstream representing a compressed version of a video or a static picture, and an output of the decoder 200 may be a decoded video consisting of a series of pictures or a decoded static picture.

An input bitstream of the decoder 200 may be a bitstream generated by the encoder 100. The parsing unit 201 parses the input bitstream and acquires values of the syntax elements from the input bitstream. The parsing unit 201 converts the binary representations of the syntax elements into numerical values and transmits the numerical values to units in the decoder 200 to acquire one or more decoded pictures. The parsing unit 201 may also parse one or more syntax elements from the input bitstream to display a decoded picture.

During a decoding process of the decoder 200, the parsing unit 201 transmits the values of the syntax elements and one or more variables set or determined according to the values of the syntax elements and used to acquire one or more decoded pictures to the units in the decoder 200.

The prediction unit 202 determines a prediction block of a current decoding block (e.g., CU). The prediction unit 202 may include a motion compensation unit 203 and an intra prediction unit 204. In some implementation, in a case where the inter decoding mode is indicated to be used to decode the current decoding block, the prediction unit 202 passes relevant parameters from the parsing unit 201 to the motion compensation unit 203 to acquire the inter prediction block; in a case where the intra prediction mode is indicated to be used to decode the current decoding block, the prediction unit 202 transmits the relevant parameters from the parsing unit 201 to the intra prediction unit 204 to acquire the intra prediction block.

The inverse quantization unit 205 has a same function as the inverse quantization unit 110 in the encoder 100. The inverse quantization unit 205 performs a scaling operation on the quantization coefficients (i.e., levels) from the parsing unit 201 to acquire reconstructed coefficients.

The inverse transform unit 206 has a same function as the inverse transform unit 111 in the encoder 100. The inverse transform unit 206 performs one or more transform operations (i.e., inverse operations of one or more transform operations performed by the inverse transform unit 111 in the encoder 100) to acquire a reconstructed residual.

The adder 207 performs an addition operation on its inputs (e.g., the prediction block from the prediction unit 202 and the reconstructed residual from the inverse transform unit 206) to acquire a reconstructed block of the current decoded block. The reconstructed block is further transmitted to the prediction unit 202 to be used as a reference for other blocks encoded in the intra prediction mode.

After all CUs in a picture or a sub-picture are reconstructed, the filtering unit 208 performs in-loop filtering on the reconstructed picture or sub-picture. The filtering unit 208 includes one or more filters, such as a deblocking filter, a sampling adaptive compensation filter, a neural network-based filter. Alternatively, in a case where the filtering unit 208 determines that the reconstructed block is not used as a reference for decoding other blocks, the filtering unit 208 performs in-loop filtering on one or more target samples in the reconstructed block. The output of the filtering unit 208 is a decoded picture or sub-picture, and the decoded picture or sub-picture is buffered to the DPB unit 209. The DPB unit 209 outputs a decoded picture or sub-picture according to the timing and control information. The pictures stored in the DPB unit 209 may also be used as references for performing inter prediction or intra prediction through the prediction unit 202.

Furthermore, the decoder 200 may include a first processor and a first memory recording a computer program. When the first processor reads and runs the computer program, the decoder 200 reads an input bitstream and generates a corresponding decoded video. In addition, the decoder 200 may also be a computing device with one or more chips. These units implemented as integrated circuits on a chip have similar connections and data exchange functions as the corresponding units in FIG. 2C.

It should also be noted that when the embodiments of the present disclosure are applied to the encoder 100, the “current block” refers to the current transform block to be encoded in the video picture; when the embodiments of the present disclosure are applied to the decoder 200, the “current block” refers to the current transform block to be decoded in the video picture. In addition, the current block here may be a current encoding unit, a current prediction unit, or a current decoding unit, etc., which is not limited in the embodiments of the present disclosure.

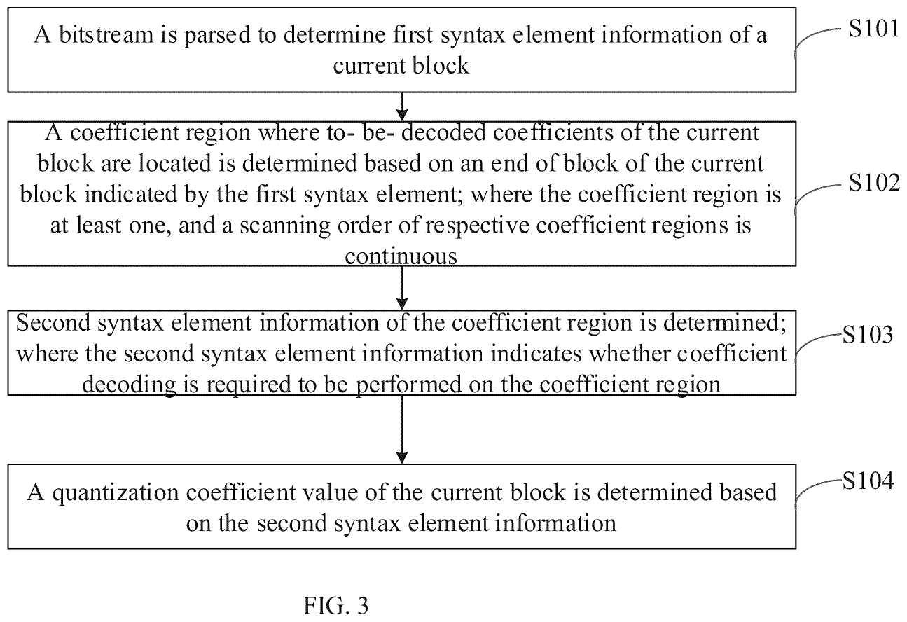

In an embodiment of the present disclosure, referring to FIG. 3, a schematic flowchart of a decoding method provided by embodiments of the present disclosure is illustrated. As shown in FIG. 3, the method may include S101 to S104.

In S101, a bitstream is parsed to determine first syntax element information of a current block.

A decoding method provided by the embodiments of the present disclosure is applied to a decoder, and in particular, to a decoder in AVM. In addition, the decoding method may be a decoding method related to a syntax element design, in which, after partitioning the coefficient region according to a scanning order of a current block, the high-level syntax is designed and the region coding flag bit is determined in a case where there are all zero coefficients in the coefficient region, so as to apply a usage of the region coding flag to the coding process in the coding process to facilitate a judgment of whether to encode and decode, reduce the code word, reduce the bitrate of coding, and improve efficiency and performance of coding.

In the embodiments of the present disclosure, in response to that coding is performed on a video sequence, a video sequence may include multiple pictures, each picture may include multiple segments, each segment may include many blocks, and the present disclosure describes the encoding and decoding process in a unit of a block.

In the embodiments of the present disclosure, when the encoder transmits a bitstream to the decoder, the decoder will decode in an order of parsing sequence-level information, frame-level information, segment-level information, block-level information.

It should be noted that, when encoding, the encoder, upon encoding, may use the region coding flag to encode the current block to reduce the encoding bitrate and improve the encoding performance. Accordingly, during decoding, the decoder also needs to use different decoding modes to decode the region coding flag of the current block. In the process of decoding the coefficients of each block, it is necessary to first determine where a last non-zero coefficient in the current block is, because the coefficients after the last non-zero coefficient are all 0 and do not need to be coded. In the embodiments of the present disclosure, the decoder performs a process of decoding first coefficients before the last non-zero coefficient. For the coefficients with continuous scanning order numberings that may exist in the first coefficient, the region coding flag in the coefficient region partitioned according to the scanning order may be used to determine whether the coefficient is zero or not, whether coding has been performed, etc., via the region coding flag in the coefficient region in which the region coding flag is located, so as to perform corresponding decoding, thereby improving decoding efficiency. Therefore, the decoder, upon parsing the bitstream, will parse a series of sequence header information sets, first parse out the sequence-level information, and then parse out a block-level end of block (eob) (e.g., first syntax element information) level by level.

The first syntax element information characterizes a block-level flag. In the embodiments of the present disclosure, the first syntax element information characterizes a number of coefficients in the current block that need to be encoded. Exemplarily, the first syntax element information may be indicated as eob. Where eob is used to indicate the block-level end of block.

It should be noted that in the embodiments of the present disclosure, if a single scan is performed according to a current scanning order to decode the coefficients of the current block, the end of block may be a value of the scanning order numbering corresponding to the last non-zero coefficient in the current block plus one, where the scanning order numbering starts from 0. In addition, a starting numbering of the scanning order numbering is not limited in the embodiments of the present disclosure.

S102, a coefficient region where to-be-decoded coefficients of the current block are located is determined based on an end of block of the current block indicated by the first syntax element; where the coefficient region includes one or more coefficient regions, and scanning orders of respective coefficient regions are continuous.

In the embodiments of the present disclosure, when the decoder parses the first syntax element information, the decoder obtains the end of block of the current block, and may also obtain which is the last non-zero coefficient of the current block, so that all scanning positions of the coefficients of the current block to be decoded may be obtained.

It should be noted that in the embodiments of the present disclosure, the decoder, upon decoding, will partition the current block into at least one coefficient region with a continuous scanning order according to the scanning order, and the scanning order numberings of the coefficients in each coefficient region are also continuous. That is, coefficients at every multiple continuous scanning positions of the current block are partitioned into a same region. In this way, after the decoder obtains all the scanning positions of the coefficients of the current block to be decoded, the decoder may determine which coefficient regions where the to-be-decoded coefficients are located.

In the embodiments of the present disclosure, the partition of the coefficient region is meaningful only when there are multiple coefficient regions, but it does not exclude a case where there is only one coefficient region. Numbers of to-be-decoded coefficients corresponding to respective coefficient regions are the same or different; and the one or more coefficient regions include non-zero coefficients.

It should be noted that, if the current block is a current decoding unit, the current block may include multiple transform blocks, and each transform block may be partitioned into at least one region. In the embodiments of the present disclosure, the current block is a transform block, and the transform block may be partitioned into at least one region, each of which contains at least one to-be-decoded coefficient.

In the embodiments of the present disclosure, a preset scanning order may be diagonal scan, Zigzag scan, Diagonal scan, row scan, column scan, or any other scanning order, which is not limited herein.

In some embodiments of the present disclosure, the current block is partitioned according to a scanning order of the current block, to determine at least one coefficient region; where each coefficient region corresponds to multiple to-be-decoded coefficients, and indexes of the scanning order corresponding to the to-be-decoded coefficients in each coefficient region are continuous; respective region indexes of the at least one coefficient region are determined according to a region arrangement order.

In the embodiments of the present disclosure, during a coefficient decoding process, the scanning order or the scanning order corresponding to the coefficient may be numbered to obtain a scanning order numbering, and each coefficient corresponds to a scanning order numbering. The decoder partitions the coefficients of N continuous scanning order numberings into a region according to the scanning order. That is, each coefficient region corresponds to multiple to-be-decoded coefficients, and scanning order indexes (scanning order numbering) corresponding to respective to-be-decoded coefficients are continuous. In this way, the transform block may be partitioned into multiple coefficient regions. The coefficient regions may be numbered, and respective region indexes may be determined for at least one coefficient region according to the region arrangement order, where the scanning order numberings of coefficients between adjacent region indexes between coefficient regions are also continuous; the region indexes may be continuous numerical numbers. In this way, if continuous coefficients are all zero, it is possible to determine whether the coefficients in the coefficient region need to be encoded by indicating the region-level encoding flag. If the continuous coefficients are all zero, there is no need to decode or encode all of them, thus reducing the coding overhead.

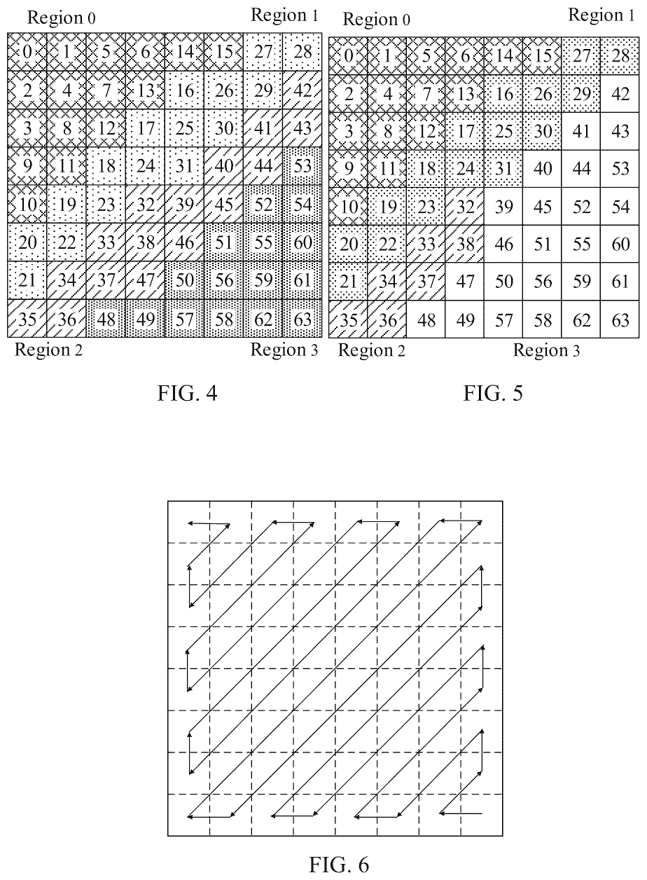

Exemplarily, for a transform block as shown in FIG. 4, taking AVM as an example, for a transform block of 8×8 size using a reverse ZigZag scanning order, the region arrangement order is an order from an upper left corner to a lower right corner. When each coefficient region is of an equal size (each region contains 16 coefficients), the transform block may be partitioned into four regions as shown in FIG. 4. The coefficients with scanning order numberings 0 to 15 are located in region 0, the coefficients with scanning order numberings 16 to 31 are located in region 1, the coefficients with scanning order numberings 32 to 47 are located in region 2, and the coefficients with scanning order numberings 48 to 63 are located in region 3.

It should be noted that each transform block may be partitioned into one or more regions. When each transform block are partitioned into multiple regions, the sizes of different regions may be different or the same.

In AVM, each transform block includes M sample values, and each of the multiple partitioned regions has N sample values, where N is less than M. The N samples are continuous in coefficient coding scanning order, and these quantization coefficients include zero or non-zero coefficients. It may also be partitioned into multiple regions that are continuous in scanning order but have different numbers of samples in the regions. To facilitate determining locations of the regions, the regions are numbered sequentially starting with number 0 for the upper left corner and incrementing toward the lower right corner.

In the embodiments of the present disclosure, determining the coefficient region where the to-be-decoded coefficients of the current block are located based on the end of block of the current block indicated by the first syntax element includes: determining a first scanning order index where a last non-zero coefficient is located based on the end of block of the current block indicated by the first syntax element; determining a first coefficient region to which the first scanning order index belongs based on a correspondence between the scanning order index and the coefficient region; and in a case where the first coefficient region is not a last scan region, determining a second coefficient region to be scanned after the first coefficient region according to the region arrangement order; the first coefficient region and the second coefficient region are coefficient regions where the to-be-decoded coefficients of the current block are located.

In the embodiments of the present disclosure, when the decoder determines the first scanning order index of the last non-zero coefficient, i.e., the scanning order numbering, the coefficient region to which the first scanning order index belongs may be determined based on the correspondence between the scanning order index and the coefficient region (the correspondence obtained upon partitioning: which region index corresponds to which coefficients, i.e., which scanning order numberings). In the embodiments of the present disclosure, in a process of scanning in reverse order starting from the last non-zero coefficient indicated by the first syntax element information, the coefficient at the upper left corner is generally the DC coefficient, in a case where the first coefficient region where the last non-zero coefficient scanned by the decoder is located is not the last scan region, it may be known how many coefficient regions to be scaned based on the region index of the first coefficient region where the last non-zero coefficient is located. In a case where the first coefficient region is not a last scan region, a second coefficient region to be scanned after the first coefficient region is determined according to the region arrangement order; the first coefficient region and the second coefficient region are coefficient regions where the to-be-decoded coefficients of the current block are located. In a case where the first coefficient region is the last scan region, the first coefficient region is determined as the coefficient region where the to-be-decoded coefficients of the current block are located.

Exemplarily, in combination with FIG. 4, and as shown in FIG. 5, coefficient scan usually starts from a position of the last non-zero coefficient. In AV1, eob (end of block) is used to represent a number of to-be-encoded coefficients in the current transform block, so that the scanning order numbering of the last non-zero coefficient is eob-1. Thus, a number of coefficient regions actually contained in the current block may be obtained. Taking eob as 39 as an example, the first scanning order index of the last non-zero coefficient is 38, and the coefficient scan starts from the location with numbering 38 and ends at the DC coefficient in the upper left corner (numbering 0), where 3 coefficient regions are contained in total, and the corresponding scanning order numberings range of the 3 coefficient regions are 0-15, 16-31, and 32-38, corresponding to region 0, region 1, and region 2 respectively. Region 0, region 1, and region 2 are region indexes.

S103, second syntax element information of the coefficient region is determined; where the second syntax element information indicates whether coefficient decoding is required to be performed on the coefficient region.

In the embodiments of the present disclosure, the mode of determining the second syntax element information corresponding to each coefficient region is not limited. One mode is that a decoder may directly parse the second syntax element information of each coefficient region from the bitstream. That is, the encoder, upon encoding, transmits the second syntax element information of all coefficient regions to the decoder through the bitstream. That is, the bitstream is parsed to determine the second syntax element information corresponding to the coefficient region. One mode is that the decoder and the encoder may agree on a rule, where the second syntax element information of the coefficient region that meets the rule is determined by default, and only the second syntax element information of other coefficient regions that do not meet the rule needs to be transmitted in the bitstream.

It should be noted that the second syntax element information characterizes whether the coefficient region needs to be decoded or not. Decoding is required because the coefficient region is encoded during encoding, and there are non-zero coefficients in the coefficient region; decoding is not required because the coefficients in the coefficient region are all zero during the encoder encodes the coefficient region, and the all-zero coefficients should not be encoded. Decoding is not required upon decoding, and the subsequent decoding process is determined directly based on the second syntax element information.

In the embodiments of the present disclosure, the rule may be that at least one piece of the second syntax element information of the coefficient region to which the DC coefficient belongs and the coefficient region to which the last non-zero coefficient belongs is set to a first value by default. The first value indicates that there is coefficient coding in the coefficient region where the current coefficient is located, that is, decoding is required.

In some embodiments of the present disclosure, the decoder may determine a number of coefficient regions of the coefficient region where the to-be-decoded coefficients of the current block are located; and determine pieces of second syntax element information of respective coefficient regions based on the number of coefficient regions.

A process that the decoder determines pieces of second syntax element information of the respective coefficient regions based on the number of coefficient regions is as follows:
in response to that the number of the coefficient regions is less than or equal to 2, determining that pieces of second syntax element information corresponding to the coefficient regions are all a first value; or
in response to that the number of the coefficient regions is greater than 2, determining that second syntax element of a coefficient region corresponding to a maximum region index and second syntax element of a coefficient region corresponding to a minimum region index in the coefficient region where the to-be-decoded coefficients are located are both the first value; and
determining the second syntax element of a third coefficient region by parsing the bitstream; where the third coefficient region is a coefficient region corresponding to other region indexes between the maximum region index and the minimum region index; or
determining that the second syntax element corresponding to a coefficient region where a DC coefficient is located is the first value, and determining pieces of second syntax element information of other coefficient regions by parsing the bitstream; or
determining that the second syntax element corresponding to a coefficient region where the last non-zero coefficient is located is the first value, and determining pieces of second syntax element information of other coefficient regions by parsing the bitstream.

It should be noted that the coefficient region in which the to-be-decoded coefficients are located is a coefficient region between the coefficient region where the last non-zero coefficient is located and the DC coefficient region in the at least one coefficient region, and may be a partial coefficient region(s) in at least one coefficient region.

It should be noted that in a case where the DC coefficient belongs to the first coefficient region, the last non-zero coefficient belongs to the last coefficient region in the to-be-decoded coefficient region. The coefficient regions corresponding to the DC coefficient and the last non-zero coefficient are coefficient regions corresponding to the maximum region index and the minimum region index in the to-be-decoded coefficient region, respectively. In this way, which to-be-decoded coefficient regions that do not comply with the rule may be determined by the number of coefficient regions based on the requirement of the rule.

Exemplarily, acquiring the number of coefficient regions is expressed as: region_sets=get_region_num(eob).

In some embodiments of the present disclosure, in response to that the number of coefficient regions is equal to 1 (that is, there is only the coefficient region where the DC coefficient is located), corresponding second syntax element information thereof must be the first value (that is, the coefficient region with the maximum region index is also the coefficient region with the minimum region index, and corresponding second syntax element information thereof are the first value). In response to that the number of coefficient regions is less than or equal to 2 (that is, there are the coefficient region where the DC coefficient is located and the coefficient region where the last non-zero coefficient is located), these two coefficient regions will be coded, and therefore, no matter which of the two coefficient regions is agreed to be the first value, the other is parsed that second syntax element information thereof is the first value, which is unchanged. In response to that the number of coefficient regions is greater than 2, it means that there are other coefficient regions besides the coefficient region where the DC coefficient is located and the coefficient region where the last non-zero coefficient is located. Whether the coefficients in these other coefficient regions are all zero needs to be determined via respective pieces of second syntax element information parsed from the bitstream. The second syntax element information of these other coefficient regions must be parsed via the bitstream, and there is no other manner. However, in this case, if the agreed rule is that the second syntax elements of the coefficient region corresponding to the maximum region index and the coefficient region corresponding to the minimum region index in the coefficient regions where the to-be-decoded coefficients are located are both the first value, that is, pieces of second syntax element information corresponding to the DC coefficient and the last non-zero coefficient are the first value, the second syntax element information of other coefficient regions are parsed from the bitstream.

In the embodiments of the present disclosure, the second syntax element information may be the first value, or the second value (that is, no decoding is required). In response to that the value of the second syntax element information is the first value, it is determined that the second syntax element information indicates that there is coefficient coding in the coefficient region where the current coefficient is located; in response to that the value of the second syntax element information is the second value, it is determined that the second syntax element information indicates that there is no coefficient coding in the coefficient region where the current coefficient is located.

In the embodiments of the present disclosure, the first value and the second value are different, and the first value and the second value may be in parameter form or in numerical form. In some implementation, the first syntax element information may be a parameter written in a profile, or may be a value of a flag, which is not specifically limited herein.

Exemplarily, taking flag as an example, there are two manners to set flag: enable flag (enable_flag) and disable flag (disable_flag). It is assumed that a value of the enable flag is the first value, and the value of the disable flag is the second value; then for the first value and the second value, the first value may be set to 1, and the second value may be set to 0; or the first value may also be set to true, and the second value may also be set to false; however, the embodiments of the present disclosure do not impose specific limitation thereto.

Exemplarily, the second syntax element information may be indicated as region_flag[setIdx], where setIdx is a region index.

Exemplarily, based on FIG. 5, according to the partitoned coefficient regions, a region coding flag (region_flag) may be set for each coefficient region. If region_flag is 0, it means that the coefficients of the current coefficient region are skipped for decoding, and the values of the coefficients in this coefficient region are all 0; if region_flag is 1, it means that the coefficients of the current coefficient region need to be obtained by parsing the bitstream, and the values of the coefficients in the coefficient region are obtained according to the default parsing scheme in the standard. The flag corresponding to each coefficient region is region_flag[setIdx], where setIdx indicates a numbering of the region (region 0, region 1, region 2 and region 3). In addition, a region coding flag of the coefficient region where the DC coefficient is located and the coefficient region where the last non-zero coefficient is located is 1 by default, and may be obtained without parsing the bitstream.

S104, a quantization coefficient value of the current block is determined based on the second syntax element information.

In the embodiments of the present disclosure, after determining the second syntax element information of the to-be-decoded coefficient, the decoder may determine whether to perform bitstream parsing on respective coefficients based on the coefficient region where the coefficient is located during the scanning process on coefficients, thereby determining quantization coefficients of respective coefficients and further obtaining a quantization coefficient value of the current block.

In some embodiments of the present disclosure, the decoder scans a current coefficient of the current block, determines a first quantization coefficient of the current coefficient of the current block based on second syntax element information of a coefficient region where the current coefficient is located; continues to scan a next coefficient of the current block based on second syntax element information of a coefficient region where the next coefficient of the current block is located in a scanning order, until the first quantization coefficients of the coefficients of the current block are determined, where a first coefficient of the current block is a coefficient indicated by the scanning order index corresponding to the end of block; and determines the quantization coefficient value of the current block based on the first quantization coefficients of the respective coefficients.

In the embodiments of the present disclosure, the decoder scans the entire transform block in a scanning order. In a process of scanning the coefficient at each scan position, it is necessary to determine the subsequent decoding process based on the second syntax element information of the coefficient region where each coefficient is located, so as to determine the first quantization coefficient of the coefficient. After traversing all the coefficients, first quantization coefficients of respective coefficients of the current block may be obtained. The decoder may determine the second quantization coefficients of respective scan positions based on the first quantization coefficient of respective coefficients obtained after the first scan and in combination with the second scan. By combining the first quantization coefficient and the second quantization coefficient corresponding to each scan position, the quantization coefficient value of the current block may be obtained.

Exemplarily, based on FIG. 5, the decoding process may be as follows.

1. a bitstream is parsed to acquire an end of block (eob) of a current block, and a number of to-be-encoded coefficients is determined.

2. when a number of coefficient regions (region_sets) into which the current block is partitioned is determined according to the number of to-be-encoded coefficients. For example, eob is 39, the current block is partitioned into according to the fact that each region contains 16 coefficients, and the number of coefficient regions is three.

3. If a number of coefficient regions in the current block is less than or equal to 2, that is, region_sets≤2, no special processing is performed; if the number of coefficient regions in the current block is greater than 2, that is, region_sets>2, the bitstream is parsed and the region coding flags corresponding to the region numberings from region_sets-2 to 1 are acquired in sequence. Region 0 is not acquired because the DC coefficient is usually in region 0.

It should be noted that the following implementations are also possible.

If region_sets is less than or equal to 3 (i.e., region_sets≤3), region 0 and region 2 default to 1, region 1 determines that the region coding flag is 1, and then decodes directly; region 1 determines that the region coding flag is 0, and then skips decoding.

If region_sets is less than or equal to 1 (i.e., region_sets≤1), the default region coding flag of region 0 is 1.

4. The coefficients are prepared to traverse in a scanning order. The scanning order numbering of the current coefficient is c (it should be the numbering starting from eob-1), and its value starts from eob-1. The scanning order is a reverse Zigzag scan.

In general, a scanning order of a zig-zag scan starts from the position where a last non-zero coefficient is located. In different standards, the manners of expressing this position are different. In AV1, eob is used to indicate a number of to-be-encoded coefficients in the current transform block, so as to determine the initial scan position, and then the coefficients are scanned in the zig-zag scanning order, and finally end at the position of the DC coefficient in the upper left corner. In AV1, a common coefficient scan manner is a schematic diagram of an 8×8 reverse zig-zag scan as shown in FIG. 6.

5. A region coding flag of the region to which the current coefficient belongs is determined. If its value is 1, parsing the bitstream is continued, identifiers 1 to 5 are obtained, and partial coefficient values are obtained; if its value is 0, a process of parsing identifiers 1 to 5 is skipped, the partial coefficient values are set to 0, and a next coefficient are continued to be scanned, until the scan ends in a case where c is 0.

6. Sign bits and other information of respective coefficients are parsed based on the partial coefficient values, to obtain a quantization coefficient value of the current block.

Exemplarily, an implementation is described via a syntax table in Table 2.

TABLE 2

| | | Notes |
|---|---|---|
| ... | | Parsing related information, such as eob |
| region_sets = get_region_num(eob) | | Acquiring the number of regions |
| region_flag[region_sets] = { 1 } | | Initializing an array that records region |
| if (region_sets > 2) { | | |
| for (setIdx = region_sets− 2; setIdx > | | Traversing a coefficient region |
| 0; setIdx−−) { | | |
| region_flag[setIdx] | S( ) | Decoding a region coding flag |
| } | | |
| } | | |
| for (c = eob − 1; c >= 0; c−− ) { | | Scanning from eob to end |
| pos = scan[ c ] | | Acquiring a position of a current scanning |
| | | point in a transform block |
| if (region_flag[get_regionIdx(c)]) { | | Acquiring a region code flag of a region |
| | | where a current coefficient is located |
| if ( c == ( eob − 1 ) ) { | | |
| coeff_base_eob | S( ) | Decoding a flag of a last non-zero |
| | | coefficient |
| level = coeff_base_eob + 1 | | |
| } else { | | |
| coeff_base | S( ) | Decoding flag 1 of last other coefficients |
| level = coeff_base | | |
| } | | |
| if (level > NUM_BASE_LEVLS) { | | |
| for ( idx = 0; | | |
| idx < | | |
| COEFF_BASE_RANGE / ( BR_CDF_SIZE | | |
| idx++ ) { | | |
| coeff_br | S( ) | Decoding flags 2 to 5 according to |
| | | conditions |
| level += coeff_br | | |
| if ( coeff_br < ( BR_CDF_SIZE − | | |
| 1 ) ) | | |
| break | | |
| } | | |
| } | | |
| Quant[ pos ] = level | | Calculating partial coefficient values |
| } | | |
| } | | |
| for ( c = 0; c < eob; c++ ) { | | Scanning from end to eob |
| pos = scan[ c ] | | |
| if ( Quant[ pos ] != 0 ) { | | Determining whether the current |
| | | coefficient is a non-zero coefficient |
| if ( c == 0 ) { | | |
| dc_sign | S( ) | Decoding a flag of a DC coefficient |
| sign = dc_sign | | |
| } else { | | |
| sign_bit | L(1) | Decoding flags of non-DC coefficients |
| sign = sign_bit | | |
| } | | |
| } else { | | |
| sign = 0 | | Setting a default flag for a zero coefficient |
| } | | |
| ... | | Completing a remaining part of |
| | | coefficient decoding |

According to the aforementioned implementing description, a size of each coefficient region is set to 16. A practical usage case for a decoder is as follows.

An 8×8 transform block uses zig-zag scan and eob is 39, the coefficients are decoded in an order of scanning numbering 38, 20, . . . , 0. According to the method of the present scheme, if the number of coefficient regions of the current block is 3, then there are region_flag[0], region_flag[1] and region_flag[2]. Region_flag [0] and region_flag[2] respectively indicate the region coding flags of the region to which the DC coefficient belongs and the region to which the last non-zero coefficient belongs, and default values thereof are 1. Region_flag [1] indicates the region coding flag of the region to which the coefficients with numberings 16 to 31 belong, and a value of region_flag[1] is parsed from the bitstream. If the value of region_flag[1] is 1, the bitstream parsing process is completed normally; if the value of region_flag[1] is 0, the bitstream parsing process of identifiers 1-5 coefficients with numberings 16 to 31 is skipped.

According to the aforementioned implementing description, the size of each coefficient region is set to 16. A practical usage case for a decoder is as follows.

An 8×8 transform block uses zig-zag scan and eob is 10, the coefficients are decoded in an order of scanning numberings 9, 8, . . . , 0. According to the method of the present scheme, if the number of coefficient regions of the current block is 1, then there is region_flag[0], region_flag[0] indicates the region coding flag to which the DC coefficient belongs, and default value thereof is 1. The subsequent bitstream parsing process is completed normally.

According to the aforementioned implementing description, the size of each coefficient region is set to 16. A practical usage case for a decoder is as follows.

An 8×8 transform block uses zig-zag scan and eob is 22, the coefficients are decoded in an order of scanning numberings 21, 20, . . . , 0. According to the method of the present scheme, if the number of coefficient regions of the current block is 2, then there are region_flag[0] and region_flag[1]. Region_flag [0] and region_flag[1] respectively indiacte the region coding flags of the region to which the DC coefficient belongs and the region to which the last non-zero coefficient belongs, and default values thereof are 1. The subsequent bitstream parsing process is completed normally.

It may be understood that for a transform block containing non-zero coefficients, the transform block may be partitioned into more than one coefficient region, where at least one coefficient region includes non-zero quantization coefficients, and sizes of respective coefficient regions may be the same or different. A region coding flag is set for each coefficient region. There may be a large number of continuous zero coefficients in the transformed quantization coefficients. In response to that the coefficient region is all zero coefficients, only one region coding flag is encoded for indication, so that the coefficient value may be determined via the region coding flag during decoding. It is not necessary to obtain the coefficient value by parsing the bitstream, which may save code word consumption.

It should be noted that, in a process of determining the first quantization coefficient, the decoder may also change the decoding process by changing the meaning of the second syntax element information which is different from the above.

In some embodiments of the present disclosure, the decoder scans the current coefficient of the current block, and based on the second syntax element information of the coefficient region where the current coefficient is located, determines the first quantization coefficient of the current coefficient of the current block as follows:
in a case where the current coefficient of the current block is scanned and the second syntax element information of the coefficient region where the current coefficient is located indicates that there is no coefficient coding in the current coefficient region where the current coefficient is located, determining that the first quantization coefficient of the current coefficient of the current block is zero; or
in a case where the current coefficient of the current block is scanned and the second syntax element information of the coefficient region where the current coefficient is located indicates that there is coefficient coding in the current coefficient region where the current coefficient is located, parsing the bitstream to determine the first quantization coefficient of the current coefficient of the current block.

It should be noted that if the second syntax element information indicates that there is no coefficient coding, it means that during encoding, all coefficients in the coefficient region where the coefficient is located are continuous all-zero coefficients, and these coefficients do not need to be encoded. During decoding, these coefficients may be assigned to 0, and do not need to be encoded or transmitted via the bitstream, thereby saving coding overhead and transmission overhead. The second syntax element information indicates there is coefficient coding, which means that during encoding, there are encoded coefficients in the coefficient region where the coefficient is located, so it needs to be parsed via the bitstream.

In some embodiments of the present disclosure, the operation that the decoder scans the current coefficient of the current block, and determines the first quantization coefficient of the current coefficient of the current block based on the second syntax element information of the coefficient region where the current coefficient is located, includes:
if the second syntax element information of the coefficient region where the current coefficient is located indicates that there is no coefficient coding in a current coefficient region where the current coefficient is located except the DC coefficient, in response to that the current coefficient is a non-DC coefficient, determining that a first quantization coefficient of the non-DC coefficient is zero, or in response to that the current coefficient is the DC coefficient, parsing the bitstream to determine the first quantization coefficient corresponding to the DC coefficient; and
if the second syntax element information of the coefficient region where the current coefficient is located indicates that there is coefficient coding except the DC coefficient in the current coefficient region where the current coefficient is located, parsing the bitstream to determine the first quantization coefficient of the current coefficient of the current block.

When the second syntax element information of a coefficient region where the DC coefficient is located is a first value, it characterizes that there is coefficient coding in the current coefficient region where the current coefficient is located except the DC coefficient.

When the second syntax element information of the coefficient region where the DC coefficient is located is the second value, it characterizes that there is no coefficient coding in the current coefficient region where the current coefficient is located except the DC coefficient.

In some embodiments of the present disclosure, the operation that the decoder scans the current coefficient of the current block, and determines the first quantization coefficient of the current coefficient of the current block based on the second syntax element information of the coefficient region where the current coefficient is located, includes:
in a case where the second syntax element information of the coefficient region where the current coefficient is located indicates that there is no coefficient coding in the current coefficient region where the current coefficient is located except the last non-zero coefficient, in response to that the current coefficient is not the last non-zero coefficient, determining that the first quantization coefficient of the current coefficient is zero, or in response to that the current coefficient is the last non-zero coefficient, determining that the first quantization coefficient corresponding to the last non-zero coefficient by parsing the bitstream; and
in a case where the second syntax element information of the coefficient region where the current coefficient is located indicates that there is coefficient coding in the current coefficient region where the current coefficient is located except the last non-zero coefficient, parsing the bitstream to determine the first quantization coefficient of the current coefficient of the current block.

When the second syntax element information of a coefficient region where the last non-zero coefficient is located is a first value, it characterizes that there is coefficient coding in the current coefficient region where the current coefficient is located except the last non-zero coefficient.

When the second syntax element information of the coefficient region where the last non-zero coefficient is located is the second value, it characterizes that there is no coefficient coding in the current coefficient region where the current coefficient is located except the last non-zero coefficient.

It should be noted that the semantics of the region coding flag of the region where the coefficient is located are adjusted. The region coding flag of the coefficient region to which the DC coefficient belongs or the coefficient region to which the last non-zero coefficient belongs is redefined.

When the region coding flag value of the coefficient region to which the DC coefficient belongs is the first value, it indicates that all coefficients in the current coefficient region need to be obtained by parsing the bitstream. When the region coding flag value of the coefficient region where the DC coefficient belongs is the second value, it indicates that the bitstream parsing process is skipped for the coefficients in the current region except the DC coefficient, and the values of these coefficients except the DC coefficient are 0 by default.

When the region coding flag value of the coefficient region to which the last non-zero coefficient belongs is the first value, it indicates that all coefficients in the current region need to be obtained by parsing the bitstream. When the region coding flag value of the region to which the last non-zero coefficient belongs is the second value, it indicates that the bitstream parsing process is skipped for the coefficients in the current region except the last non-zero coefficient, and the values of these coefficients except the last non-zero coefficient are 0 by default.

It may be understood that the decoder decodes the quantization coefficient values of the current block by determining the second syntax element information, and effectively controls whether to perform a decoding process on the coefficients of the current block by the high-level syntax (i.e., the second syntax element information) about whether to decode the coefficient region where the coefficients are located. And since there may be a large number of continuous all-zero coefficients in the transformed quantization coefficients, in response to that there are all zero coefficients in the coefficient region, the region coding flag is used to indicate (i.e., the second syntax element information), which may save code word consumption, reduce the decoding bitrate, and further, improve decoding efficiency and performance.

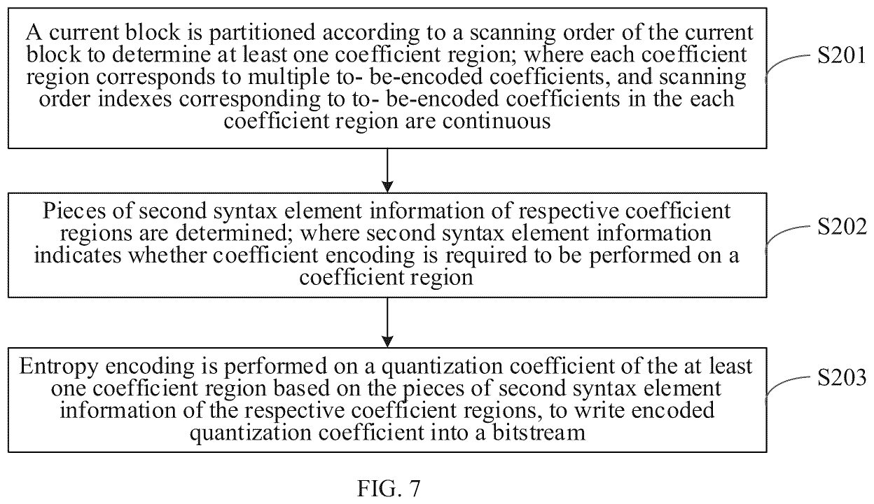

In another embodiment of the present disclosure, referring to FIG. 7, a schematic flowchart of an encoding method provided by embodiments of the present disclosure is illustrated. As shown in FIG. 7, the method may include S201-S203.

In S201, a current block is partitioned according to a scanning order of the current block, to determine at least one coefficient region; where each coefficient region corresponds to multiple to-be-encoded coefficients, and indexes of the scanning order corresponding to the to-be-encoded coefficients in each coefficient region are continuous.

A region coding flag of all-zero or non-zero quantization coefficient values included in the current coefficient region is used in AVM to decide whether to encode the current coefficient in the embodiments of the present disclosure. And according to the difference in region coding flags, encoding is performed only in one case, thereby avoiding the situation where all coefficients must be encoded, saving bitrate, and improving coding performance.

In a process of encoding the coefficients of the current block, the encoder may first partition the current block, and the encoder partitions the current block into at least one coefficient region with a continuous scanning order according to the scanning order, and the scanning order numberings of the coefficients in each coefficient region are also continuous. That is, coefficients at every multiple continuous scanning positions of the current block are partitioned into a same region. In this way, when the encoder encodes the coefficients of the current block, the coefficient region where the coefficient is located may be obtained.

In the embodiments of the present disclosure, the partitioning of the coefficient region is meaningful only when there are multiple coefficient regions, but does not exclude a case where there is only one coefficient region. Numbers of to-be-encoded coefficients corresponding to respective coefficient regions are the same or different; and the at least one coefficient region includes non-zero coefficients.

It should be noted that, if the current block is a current encoding unit, the current block may include multiple transform blocks, and each transform block may be partitioned into at least one region. In the embodiments of the present disclosure, the current block is a transform block, and the transform block may be partitioned into at least one region, each coefficient region contains multiple to-be-encoded coefficients, and indexes of the scanning order corresponding to the to-be-encoded coefficients in each coefficient region are continuous.

In the embodiments of the present disclosure, a preset scanning order may be diagonal scan, zigzag scan, diagonal scan, row scan, column scan, or any other scanning order, which is not limited herein.

In the embodiments of the present disclosure, the numbers of to-be-decoded coefficients corresponding to each coefficient region are the same or different; and the at least one coefficient region includes non-zero coefficients.

During a coefficient coding process, the scanning order or the scanning order corresponding to the coefficient may be numbered to obtain a scanning order numbering, and each coefficient corresponds to a scanning order numbering. The encoder partitions the coefficients with N continuous scanning order numbering into a region according to the scanning order. That is, each coefficient region corresponds to multiple to-be-encoded coefficients, and indexes of the scanning order (scanning order numbering) corresponding to each to-be-encoded coefficient are continuous. In this way, the transform block may be partitioned into multiple coefficient regions. The coefficient regions may be numbered, and respective region indexes may be determined for at least one coefficient region according to the region arrangement order, where scanning order numberings of coefficients between adjacent region indexes between coefficient regions are also continuous; the region indexes may be continuous numerical numbers.

In S202, pieces of second syntax element information of respective coefficient regions are determined; where second syntax element information indicates whether coefficient coding is required to be performed on a coefficient region.

In S203, entropy coding is performed on a quantization coefficient of the at least one coefficient region based on the pieces of second syntax element information of the respective coefficient regions, to write encoded quantization coefficient into a bitstream.

In the embodiments of the present disclosure, a process that the encoder determines the pieces of second syntax element information of the respective coefficient regions includes:
in a case where there is a non-zero coefficient in quantization coefficients of a third coefficient region, determining that the second syntax element information of the third coefficient region characterizes that coefficient coding needs to be performed on a corresponding coefficient region; performing entropy coding on the quantization coefficients of the third coefficient region based on the second syntax element information, to obtain first encoding information. The third coefficient region is any coefficient region of the respective coefficient regions; or
in a case where there is no non-zero coefficient in the quantization coefficients of the third coefficient region, determining that the second syntax element information of the third coefficient region characterizes that coefficient coding is not required to be performed on the corresponding coefficient region.

In this way, if continuous coefficients are all zero, the encoding flag is determined to determine whether the coefficients in the coefficient region need to be encoded. If the continuous coefficients are all zero, there is no need for encoding, thus reducing the coding overhead.

In the embodiments of the present disclosure, when the second syntax element information is a first value, it indicates that coefficient coding needs to be performed on a current coefficient region; and when the second syntax element information is a second value, it indicates that coefficient coding is not required to be performed on the current coefficient region.

In the embodiments of the present disclosure, the second syntax element information may be the first value or the second value. In response to that the value of the second syntax element information is the first value, it is determined that the second syntax element information indicates that coefficient coding needs to be performed on the coefficient region where the current coefficient is located; in response to that the value of the second syntax element information is the second value, it is determined that the second syntax element information indicates that coefficient coding is not required to performed on the coefficient region where the current coefficient is located.

In the embodiments of the present disclosure, the first value and the second value are different, and the first value and the second value may be in parameter form or in numerical form. In some implementation, the first syntax element information may be a parameter written in a profile, or may be a value of a flag, which is not specifically limited herein.

Exemplarily, taking flag as an example, there are two manners to set flag: enable flag (enable_flag) and disable flag (disable_flag). It is assumed that a value of the enable flag is the first value, and the value of the disable flag is the second value; then for the first value and the second value, the first value may be set to 1, and the second value may be set to 0; or the first value may also be set to true, and the second value may also be set to false; however, the embodiments of the present disclosure do not impose specific limitation thereto.

Exemplarily, the second syntax element information may be indicated as region_flag[setIdx], where setIdx is a region index.

The semantics of the region coding flag of the region where the coefficients are located is adjusted. The region coding flag of the coefficient region where the DC coefficient belongs or the coefficient region to which the last non-zero coefficient belongs is redefined. When the region coding flag value of the coefficient region to which the DC coefficient belongs is the first value, it indicates that there are other non-zero coefficients in the current coefficient region except the DC coefficient. Therefore, the coefficients except the DC coefficient need to be encoded. When the region coding flag value of the coefficient region to which the DC coefficient belongs is the second value, it indicates that all other coefficients in the current region except for the DC coefficient are 0, and the encoding for other coefficients may be skipped.

In some embodiments of the present disclosure, if there is a non-zero coefficient in quantization coefficients of the coefficient region where the DC coefficient is located except the DC coefficient, it is determined that the second syntax element information of the coefficient region where the DC coefficient is located characterizes that coefficient coding needs to be performed on a corresponding coefficient region except the DC coefficient; entropy coding is performed on the DC coefficient and the non-zero coefficient to obtain second encoding information to be written into the bitstream.

In some embodiments of the present disclosure, if there is no non-zero coefficient in the quantization coefficients of the coefficient region where the DC coefficient is located except the DC coefficient, it is determined that the second syntax element information of the coefficient region where the DC coefficient is located characterizes that the coefficient coding is not required to be performed on the corresponding coefficient region except the DC coefficient; entropy coding is performed on the DC coefficient to obtain third encoding information to be written into the bitstream.

The second syntax element information of the coefficient region where the DC coefficient is located is the first value, it indicates that coefficient coding needs to be performed on the current coefficient region where the current coefficient region is located except the DC coefficient; and the second syntax element information of the coefficient region where the DC coefficient is located is the second value, it indicates that coefficient coding is not required to be performed on the current coefficient region where the current coefficient region is located except the DC coefficient.

It should be noted that the region coding flag value of the coefficient region to which the last non-zero coefficient belongs is the first value, it indicates that coefficient coding is required to be performed on all coefficients in the current region. The region coding flag value of the region to which the last non-zero coefficient belongs is the second value, it indicates that the coefficients in the current region, except for the last non-zero coefficient, are all 0, and coefficient coding is not required to be performed on these coefficients except the last non-zero coefficient.

In some embodiments of the present disclosure, if there is a non-zero coefficient in quantization coefficients of a coefficient region where a last non-zero coefficient is located except a last non-zero coefficient, it is determined that the second syntax element information of the coefficient region where the last non-zero coefficient is located characterizes that coefficient coding is required to be performed on a corresponding coefficient region except the last non-zero coefficient; entropy coding is performed on the last non-zero coefficient and other non-zero coefficients to obtain fourth encoding information to be encoded into the bitstream; entropy coding is performed on the last non-zero coefficient to obtain fifth encoding information to be encoded into the bitstream.

In some embodiments of the present disclosure, if there is no non-zero coefficient in the quantization coefficients of the coefficient region where the last non-zero coefficient is located except a last non-zero coefficient, it is determined that the second syntax element information of the coefficient region where the last non-zero coefficient is located characterizes that coefficient coding is not required to be performed on the corresponding coefficient region except the last non-zero coefficient; when second syntax element information of the coefficient region where the last non-zero coefficient is located is the first value, it indicates that coefficient coding is required to be performed on the current coefficient region where the current coefficient region is located except the last non-zero coefficient; and when the second syntax element information of the coefficient region where the last non-zero coefficient is located is the second value, it indicates that the coefficient coding is not required to be performed on the current coefficient region where the current coefficient region is located except the last non-zero coefficient.

In the embodiments of the present disclosure, after the encoder determines the second syntax element information, the second syntax element information is encoded into the bitstream for use by the decoder during decoding.

In the embodiments of the present disclosure, the encoder traverses each coefficient of the current block for encoding. In the process of encoding the current coefficient of the current block, it is necessary to determine the second syntax element information where the current coefficient is located. If the second syntax element information is the first value, entropy coding is performed on the current coefficient based on the second syntax element information of each coefficient region; if the second syntax element information is the second value, encoding for the current coefficient is abandoned to continue encoding a next coefficient, until all coefficients are encoded, and record the flag of the last non-zero coefficient. That is, the encoder determines an end of block of the current block, and writes the end of block as the first syntax element information into the bitstream.

In the embodiments of the present disclosure, the encoder writes encoding information into a bitstream, where the encoding information includes at least one of: first encoding information, second encoding information, third encoding information, fourth encoding information or fifth encoding information.

It should be noted that the principle of block partitioning of the encoder and the interpretation of syntax element information are consistent with the description of the decoder, which will not be repeated herein.

It may be understood that the encoder encodes the quantization coefficient values of the current block by determining the second syntax element information, and effectively controls whether to perform encoding process on the coefficients of the current block by the high-level syntax (i.e., the second syntax element information) about whether to encode the coefficient region where the coefficients are located. And since there may be a large number of continuous all-zero coefficients in the transformed quantization coefficients, in response to that there are all zero coefficients in the coefficient region, the region coding flag is used to indicate (i.e., the second syntax element information), which may save code word consumption, reduce the encoding bitrate, and further, improve encoding efficiency and performance.

In yet another embodiment of the present disclosure, the embodiments of the present disclosure further provide a bitstream, where the bitstream is generated by bit encoding according to to-be-encoded information, and the to-be-encoded information includes at least one of:
first syntax element information, second syntax element information or encoding information of a quantization coefficient of a current block;
where the first syntax element information is used for indicating an end of block of the current block, and the second syntax element information is used for indicating whether the is required to be performed on a coefficient region at a region level of a block.

It may be understood that after the to-be-encoded information is bit encoded to generate a bitstream, the bitstream is transmitted from the encoding side to the decoding side; then at the decoding side, by parsing the bitstream, it may be determined whether the coefficients in the current block are encoded; and by parsing the bitstream, the encoding information, the first syntax element information, etc., may be determined; and by parsing the bitstream, the quantization coefficient value of the current block may also be determined.

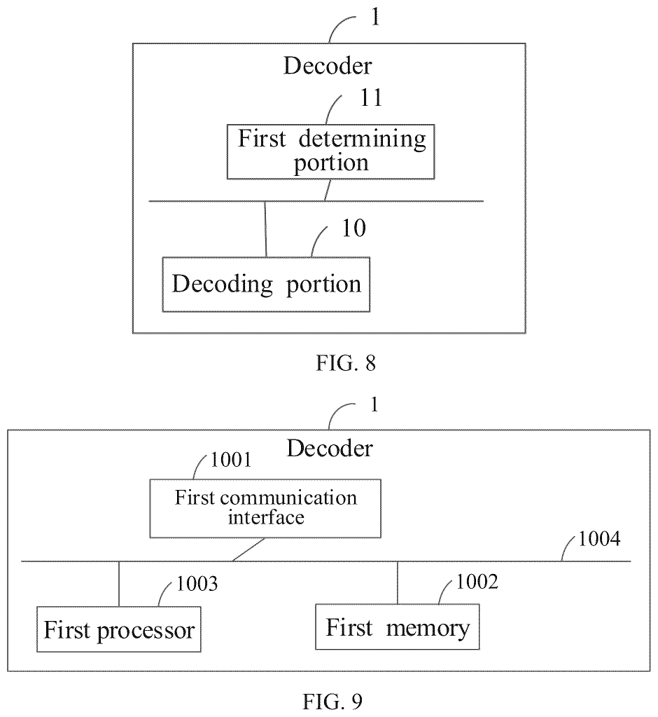

In yet another embodiment of the present disclosure, based on the same inventive concept as the aforementioned embodiments, referring to FIG. 8, a schematic diagram of a composition structure of a decoder 1 provided by embodiments of the present disclosure is illustrated. As shown in FIG. 8, the decoder 1 may include a decoding portion 10 and a first determining portion 11:
a decoding portion 10 is configured to parse a bitstream to determine first syntax element information of a current block; and
a first determining portion 11 is configured to determine a coefficient region where to-be-decoded coefficients of the current block are located based on an end of block of the current block indicated by the first syntax element information, where the coefficient region includes one or more coefficient regions, and scanning orders of respective coefficient regions are continuous; and determine second syntax element information of the coefficient region; where the second syntax element information indicates whether coefficient decoding is required to be performed on the coefficient region; the decoding portion 10 or the first determining portion 11 is configured to determine a quantization coefficient value of the current block based on the second syntax element information.

In some embodiments of the present disclosure, the decoding portion 10 is further configured to parse the bitstream to determine the second syntax element information corresponding to the coefficient region.

In some embodiments of the present disclosure, the first determining portion 11 is further configured to partition the current block according to a scanning order of the current block, to determine at least one coefficient region; where each coefficient region corresponds to multiple to-be-decoded coefficients, and scanning order indexes corresponding to the to-be-decoded coefficients in each coefficient region are continuous; determine a region index of each of the at least one coefficient region is determined according to a region arrangement order.

In some embodiments of the present disclosure, the first determining portion 11 is further configured to determine a first scanning order index where a last non-zero coefficient is located based on the end of block of the current block indicated by the first syntax element; determine a first coefficient region to which the first scanning order index belongs based on a correspondence between a scanning order index and a coefficient region; and in a case where the first coefficient region is not a last scan region, determine a second coefficient region to be scanned after the first coefficient region according to the region arrangement order; where the first coefficient region and the second coefficient region are coefficient regions where the to-be-decoded coefficients of the current block are located.

In some embodiments of the present disclosure, the first determining portion 11 is further configured to, after determining the first coefficient region to which the first scanning order index belongs based on the correspondence between the scanning order index and the coefficient region, determine the first coefficient region as the coefficient region where the to-be-decoded coefficients of the current block are located in a case where the first coefficient region is the last scan region.

In some embodiments of the present disclosure, the first determining portion 11 is further configured to determine a number of coefficient regions of the coefficient region where the to-be-decoded coefficients of the current block are located; and determine pieces of second syntax element information of the respective coefficient regions based on the number of the coefficient regions.

In some embodiments of the present disclosure, the first determining portion 11 is further configured to, in response to that the number of the coefficient regions is less than or equal to 2, determine that the pieces of second syntax element information corresponding to the coefficient regions are all a first value; or
in response to that the number of the coefficient regions is greater than 2, determine that second syntax element information of a coefficient region corresponding to a maximum region index and second syntax element information of a coefficient region corresponding to a minimum region index in the coefficient region where the to-be-decoded coefficients are located are both the first value; and the decoding portion 10 is further configured to determine second syntax element of a third coefficient region by parsing the bitstream; where the third coefficient region is a coefficient region corresponding to other region indexes between the maximum region index and the minimum region index; or
the first determining portion 11 is further configured to determine that the second syntax element corresponding to a coefficient region where a DC coefficient is located is the first value, and the decoding portion 10 is further configured to determine pieces of second syntax element information of other coefficient regions by parsing the bitstream; or
the first determining portion 11 is further configured to determine that second syntax element corresponding to a coefficient region where the last non-zero coefficient is located is the first value, and the decoding portion 10 is further configured to determine pieces of second syntax element information of other coefficient regions by parsing the bitstream.

In some embodiments of the present disclosure, the first determining portion 11 is further configured to scan a current coefficient of the current block, determine a first quantization coefficient of the current coefficient of the current block based on second syntax element information of a coefficient region where the current coefficient is located; continue to scan a next coefficient of the current block based on second syntax element information of a coefficient region where the next coefficient of the current block is located in a scanning order, until first quantization coefficients of respective coefficients of the current block are determined, where a first coefficient of the current block is a coefficient indicated by a scanning order index corresponding to the end of block; and determine the quantization coefficient value of the current block based on first quantization coefficients of the respective coefficients.

In some embodiments of the present disclosure, the first determining portion 11 is further configured to, in a case where the current coefficient of the current block is scanned and the second syntax element information of the coefficient region where the current coefficient is located indicates that there is no coefficient coding in the current coefficient region where the current coefficient is located, determine that the first quantization coefficient of the current coefficient of the current block is zero; or the decoding portion 10 is further configured to, in a case where the current coefficient of the current block is scanned and the second syntax element information of the coefficient region where the current coefficient is located indicates that there is coefficient coding in the current coefficient region where the current coefficient is located, parse the bitstream to determine the first quantization coefficient of the current coefficient of the current block.

In some embodiments of the present disclosure, in a case where the second syntax element information is a first value, it indicates that there is coefficient coding in the coefficient region where the current coefficient is located; and in a case where the second syntax element information is a second value, it indicates that there is no coefficient coding in the coefficient region where the current coefficient is located.

In some embodiments of the present disclosure, the first determining portion 11 is further configured to: in a case where the second syntax element information of the coefficient region where the current coefficient is located indicates that there is no coefficient coding in a current coefficient region where the current coefficient is located except a DC coefficient, in response to that the current coefficient is a non-DC coefficient, determine that a first quantization coefficient of the non-DC coefficient is zero, or the decoding portion 10 is further configured to parse the bitstream, to determine the first quantization coefficient corresponding to the DC coefficient in a case where the current coefficient is a DC coefficient; and
the decoding portion 10 is further configured to, in a case where the second syntax element information of the coefficient region where the current coefficient is located indicates that there is coefficient coding in the current coefficient region where the current coefficient is located except the DC coefficient, parse the bitstream to determine the first quantization coefficient of the current coefficient of the current block.

In some embodiments of the present disclosure, the first determining portion 11 is further configured to, in a case where the second syntax element information of the coefficient region where the current coefficient is located indicates that there is no coefficient coding in the current coefficient region in which the current coefficient is located except the last non-zero coefficient, in response to that the current coefficient is not the last non-zero coefficient, determine that the first quantization coefficient of the current coefficient is zero, or the decoding portion 10 is further configured to, in response to that the current coefficient is the last non-zero coefficient, determine that a first quantization coefficient corresponding to the last non-zero coefficient by parsing the bitstream; and
the decoding portion 10 is further configured to, in a case where the second syntax element information of the coefficient region where the current coefficient is located indicates that there is coefficient coding in the current coefficient region where the current coefficient is located except the last non-zero coefficient, parse the bitstream to determine the first quantization coefficient of the current coefficient of the current block.

In some embodiments of the present disclosure, in a case where the second syntax element information of a coefficient region where the DC coefficient is located is the first value, it characterizes that there is coefficient coding in the current coefficient region where the current coefficient is located except the DC coefficient; and in a case where the second syntax element information of the coefficient region where the DC coefficient is located is a second value, it characterizes that there is no coefficient coding in the current coefficient region where the current coefficient is located except the DC coefficient.

In some embodiments of the present disclosure, in a case where the second syntax element information of the coefficient region where the last non-zero coefficient is located is a first value, it characterizes that there is coefficient coding in the current coefficient region where the current coefficient is located except the last non-zero coefficient; and in a case where the second syntax element information of the coefficient region where the last non-zero coefficient is located is a second value, it characterizes that there is no coefficient coding in the current coefficient region where the current coefficient is located except the last non-zero coefficient.

In some embodiments of the present disclosure, numbers of to-be-decoded coefficients corresponding to the respective coefficient region are the same or different; and the one or more coefficient regions include non-zero coefficients.

Based on the composition of the decoder 1 and the non-transitory computer-readable storage medium, referring to FIG. 9, a schematic diagram of an exemplary hardware structure of the decoder provided by the embodiments of the present disclosure is illustrated. As shown in FIG. 9, the decoder may include: a first communication interface 1001, a first memory 1002, and a second processor 1003; and these components are coupled together via a first bus system 1004. It may be understood that the second bus system 1004 is used to achieve connection and communication among these components. The first bus system 1004 includes not only a data bus but also a power bus, a control bus and a status signal bus. However, for the sake of clarity, various buses are labeled as the first bus system 1004 in FIG. 9, where
the first communication interface 1001 is configured to receive and transmit signals during a process of transmitting and receiving information with other external network elements;
the first memory 1002 is configured to store a computer program executable on the first processor 1003; and
the first processor 1003 is configured to perform the decoding method implemented by the decoder upon running the computer program.

It may be understood that the decoder decodes the quantization coefficient values of the current block by determining the second syntax element information, and effectively controls whether to perform decoding process on the coefficients of the current block through a high-level syntax (i.e., the second syntax element information) about whether the coefficient region where the coefficients are located is decoded. And since there may be a large number of continuous all-zero coefficients in the transformed quantization coefficients, in response to that there are all zero coefficients in the coefficient region, the region coding flag is used to indicate (i.e., the second syntax element information), which may save code word consumption, reduce the decoding bitrate, and further improve decoding efficiency and performance.

The first memory 1002 in the embodiments of the present disclosure may be a volatile (transitory) memory or a non-volatile (non-transitory) memory, or may include both the volatile memory and the non-volatile memory. Here, the non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (RAM), which is used as an external cache. By way of exemplary illustration, rather than limiting illustration, many forms of RAMs are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM).

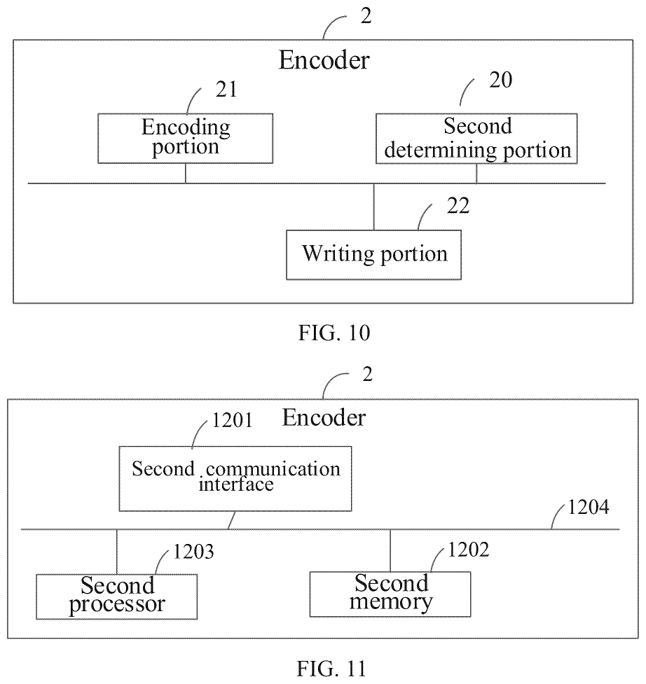

In yet another embodiment of the present disclosure, based on the same inventive concept as the aforementioned embodiments, referring to FIG. 10, a schematic diagram of a composition structure of an encoder 2 provided by the embodiments of the present disclosure is illustrated. As shown in FIG. 10, the encoder 2 may include a second determining portion 20 and an encoding portion 21:
the second determining portion 20 is configured to divide a current block to determine at least one coefficient region according to a scanning order of the current block; where each coefficient region corresponds to to-be-encoded coefficientsmultiple to-be-encoded coefficients, and indexes of the scanning order corresponding to the to-be-encoded coefficientsto-be-encoded coefficients in each coefficient region are continuous; and determine second syntax element information of each coefficient region; where second syntax element information indicates whether a coefficient coding is required to be performed on the coefficient region; and
the encoding portion 21 is configured to perform entropy coding on a quantization coefficient of at least one coefficient region based on the second syntax element information of each coefficient region, to write encoded quantization coefficient into a bitstream.

In some embodiments of the present disclosure, the second determining portion 20 is further configured to, in a case where there is a non-zero coefficient in quantization coefficients of a third coefficient region, determine that second syntax element information of the third coefficient region characterizes that coefficient coding is required to be performed on the third coefficient region; where the third coefficient region is any coefficient region of the respective coefficient regions; or in a case where there is no non-zero coefficient in the quantization coefficients of the third coefficient region, determine that the second syntax element information of the third coefficient region characterizes that coefficient coding is not required to be performed on the third coefficient region; and
the encoding portion 21 is further configured to perform entropy coding on the quantization coefficient of the third coefficient region based on the second syntax element information of the third coefficient region, to obtain first encoding information to be written into the bitstream.

In some embodiments of the present disclosure, in a case where the second syntax element information is a first value, it indicates that coefficient coding is required to be performed on a current coefficient region; and in a case where the second syntax element information is a second value, it indicates that coefficient coding is not required to be performed on the current coefficient region.

In some embodiments of the present disclosure, the second determining portion 20 is further configured to: in a case where there is a non-zero coefficient in quantization coefficients of the coefficient region where the DC coefficient is located except the DC coefficient, determine that the second syntax element information of the coefficient region where the DC coefficient is located characterizes that coefficient coding is required to be performed on a corresponding coefficient region except the DC coefficient; or
in a case where there is no non-zero coefficient in the quantization coefficients of the coefficient region where the DC coefficient is located except the DC coefficient, determine that the second syntax element information of the coefficient region where the DC coefficient is located characterizes that coefficient coding is not required to be performed on a corresponding coefficient region except the DC coefficient; and
the encoding portion 21 is further configured to perform entropy coding on the DC coefficient and the non-zero coefficient to obtain second encoding information to be written into the bitstream; or perform entropy coding on the DC coefficient to obtain third encoding information to be written into the bitstream.

In some embodiments of the present disclosure, in a case where the second syntax element information of the coefficient region where the DC coefficient is located is the first value, it characterizes that coefficient coding is required to be performed on the current coefficient region where the current coefficient region is located except the DC coefficient; and
in a case where the second syntax element information of the coefficient region where the DC coefficient is located is the second value, it characterizes that coefficient coding is not required to be performed on the current coefficient region where the current coefficient region is located except the DC coefficient.

In some embodiments of the present disclosure, the second determining portion 20 is further configured to: in a case where there is a non-zero coefficient in the quantization coefficient of the coefficient region where a last non-zero coefficient is located except the last non-zero coefficient, determine that the second syntax element information of the coefficient region where the last non-zero coefficient is located characterizes that coefficient coding is required to be performed on a corresponding coefficient region except the last non-zero coefficient; or
in a case where there is no non-zero coefficient in the quantization coefficient of the coefficient region where the last non-zero coefficient is located except a last non-zero coefficient, determine that the second syntax element information of the coefficient region where the last non-zero coefficient is located characterizes that coefficient coding is not required to be performed on a corresponding coefficient region except the last non-zero coefficient; and
the encoding portion 21 is further configured to perform entropy coding on the last non-zero coefficient and other non-zero coefficients to obtain fourth encoding information to be written into the bitstream; or perform entropy coding on the last non-zero coefficient to obtain fifth encoding information to be written into the bitstream.

In some embodiments of the present disclosure, the second syntax element information of the coefficient region where the last non-zero coefficient is located is a first value, it characterizes that coefficient coding is required to be performed on the current coefficient region where the current coefficient region is located except the last non-zero coefficient; and
the second syntax element information of the coefficient region where the last non-zero coefficient is located is a second value, it characterizes that coefficient coding is not required to be performed on the current coefficient region where the current coefficient region is located except the last non-zero coefficient.

In some embodiments of the present disclosure, the encoder 2 may further include: a writing portion 22;
the writing portion 22 is further configured to write second syntax element information into a bitstream.

In some embodiments of the present disclosure, the encoder 2 may further include: a writing portion 22;
the writing portion 22 is further configured to write encoding information into a bitstream, where the encoding information includes at least one of first encoding information, second encoding information, third encoding information, fourth encoding information or fifth encoding information.

In some embodiments of the present disclosure, the encoder 2 may further include: a writing portion 22;
the second determining portion 20 is further configured to determine an end of block of the current block; and
the writing portion 22 is further configured to write the end of block as first syntax element information into the bitstream.

In some embodiments of the present disclosure, numbers of to-be-encoded coefficients corresponding to the respective coefficient regions are the same or different; and the at least one coefficient region includes non-zero coefficients.

Based on the composition of the encoder 2 and the non-transitory computer-readable storage medium, referring to FIG. 11, a schematic diagram of an exemplary hardware structure of the encoder provided by the embodiments of the present disclosure is illustrated. As shown in FIG. 11, the encoder may include: a second communication interface 1201, a second memory 1202, and a second processor 1203; and these components are coupled together via a second bus system 1204. It may be understood that the second bus system 1204 is used to achieve connection and communication among these components. The second bus system 1204 includes not only a data bus but also a power bus, a control bus and a status signal bus. However, for the sake of clarity, various buses are labeled as the second bus system 1204 in FIG. 11, where
the second communication interface 1201 is configured to receive and transmit signals during the process of transmitting and receiving information with other external network elements;
the second memory 1202 is configured to store a computer program executable on the second processor 1203; and
the second processor 1203 is configured to perform the encoding method implemented by the encoder when running the computer program.

It may be understood that the encoder encodes the quantization coefficient values of the current block by determining the second syntax element information, and effectively controls whether to perform encoding process on the coefficients of the current block through the high-level syntax (i.e., the second syntax element information) about whether the coefficient region where the coefficients are located is encoded. And since there may be a large number of continuous all-zero coefficients in the transformed quantization coefficients, in response to that there are all zero coefficients in the coefficient region, the region coding flag is used to indicate (i.e., the second syntax element information), which may save code word consumption, reduce the encoding bitrate, and further improve encoding efficiency and performance.

The embodiments of the present disclosure provide a computer storage medium. The non-transitory computer storage medium stores a computer program, when the computer program is executed by a first processor, a decoding method of a decoder is implemented, or when the computer program is executed by a second processor, an encoding method of an encoder is implemented.

The above contents are only exemplary implementations of the present disclosure, but the protection scope of the present disclosure is not limited thereto.

### INDUSTRIAL APPLICABILITY

In the embodiments of the present disclosure, at an encoding side or a decoding side, the quantization coefficient values of the current block are coded by determining second syntax element information, whether to perform decoding process on the coefficients of the current block is controlled effectively by a high-level syntax (i.e., second syntax element information) about whether the coefficient region where the coefficients are located is coded. And since there may be a large number of continuous zero coefficients in the coefficients after transform quantization, in a case where there are all zero coefficients in in the coefficient region, the region coding flag is used to indicate (i.e., the second syntax element information), which may save the code word consumption, reduce the coding bitrate, and further improve the coding efficiency and performance.

In a first clause, a decoding method applied to a decoder is provided, which includes:
parsing a bitstream to determine first syntax element information of a current block;
determining a coefficient region where to-be-decoded coefficients of the current block are located based on an end of block of the current block indicated by the first syntax element information; wherein the coefficient region includes one or more coefficient regions, and scanning orders of respective coefficient regions are continuous;
determining second syntax element information of the coefficient region; where the second syntax element information indicates whether coefficient decoding is required to be performed on the coefficient region; and
determining a quantization coefficient value of the current block based on the second syntax element information.

In a second clause, according to the first clause, where determining the second syntax element information of the coefficient region includes:
parsing the bitstream to determine the second syntax element information corresponding to the coefficient region.

In a third clause, according to the first clause or the second clause, where the method further includes:
partitioning the current block according to a scanning order of the current block, to determine at least one coefficient region; where each of the at least one coefficient region corresponds to multiple to-be-decoded coefficients, and scanning order indexes corresponding to the to-be-decoded coefficients in each of the at least one coefficient region are continuous; and
determining a region index of each of the at least one coefficient region according to a region arrangement order.

In a fourth clause, according to the first clause, where determining the coefficient region where the to-be-decoded coefficients of the current block are located based on the end of block of the current block indicated by the first syntax element information includes:
determining a first scanning order index where a last non-zero coefficient is located based on the end of block of the current block indicated by the first syntax element information;
determining a first coefficient region to which the first scanning order index belongs based on a correspondence between a scanning order index and a coefficient region; and
in a case where the first coefficient region is not a last scan region, determining a second coefficient region to be scanned after the first coefficient region according to a region arrangement order;
where the first coefficient region and the second coefficient region are coefficient regions where the to-be-decoded coefficients of the current block are located.

In a fifth clause, according to the fourth clause, where after determining the first coefficient region to which the first scanning order index belongs based on the correspondence between the scanning order index and the coefficient region, the method further includes:
in a case where the first coefficient region is the last scan region, determining the first coefficient region as the coefficient region where the to-be-decoded coefficients of the current block are located.

In a sixth clause, according to the first clause, the fourth clause or the fifth clause, where determining the second syntax element information of the coefficient region includes:
determining a number of coefficient regions of the coefficient region where the to-be-decoded coefficients of the current block are located; and
determining pieces of second syntax element information of the respective coefficient regions based on the number of coefficient regions.

In a seventh clause, according to the sixth clause, where determining the pieces of second syntax element information of the respective coefficient regions based on the number of coefficient regions includes:
in response to that the number of coefficient regions is less than or equal to 2, determining that the pieces of second syntax element information corresponding to the coefficient regions are all a first value; or
in response to that the number of coefficient regions is greater than 2, determining that second syntax element information of a coefficient region corresponding to a maximum region index and second syntax element information of a coefficient region corresponding to a minimum region index in the coefficient region where the to-be-decoded coefficients are located are both the first value; and determining second syntax element information of a third coefficient region by parsing the bitstream; where the third coefficient region is a coefficient region corresponding to other region indexes between the maximum region index and the minimum region index; or
determining that second syntax element information corresponding to a coefficient region where a DC coefficient is located is the first value, and determining pieces of second syntax element information of other coefficient regions by parsing the bitstream; or
determining that second syntax element information corresponding to a coefficient region where a last non-zero coefficient is located is the first value, and determining pieces of second syntax element information of other coefficient regions by parsing the bitstream.

In an eighth clause, according to any one of the first clause to the seventh clause, where determining the quantization coefficient value of the current block based on the second syntax element information includes:
scanning a current coefficient of the current block, and determining a first quantization coefficient of the current coefficient of the current block based on second syntax element information of a coefficient region where the current coefficient is located; continuing to scan a next coefficient of the current block based on second syntax element information of a coefficient region where the next coefficient of the current block is located in a scanning order until first quantization coefficients of respective coefficients of the current block are determined; where a first coefficient of the current block is a coefficient indicated by a scanning order index corresponding to the end of block; and
determining the quantization coefficient value of the current block based on the first quantization coefficients of the respective coefficients.

In a ninth clause, according to the eighth clause, where scanning the current coefficient of the current block, and determining the first quantization coefficient of the current coefficient of the current block based on the second syntax element information of the coefficient region where the current coefficient is located includes:
in a case where the current coefficient of the current block is scanned and the second syntax element information of the coefficient region where the current coefficient is located indicates that there is no coefficient coding in the current coefficient region where the current coefficient is located, determining that the first quantization coefficient of the current coefficient of the current block is zero; or
in a case where the current coefficient of the current block is scanned and the second syntax element information of the coefficient region where the current coefficient is located indicates that there is coefficient coding in the current coefficient region where the current coefficient is located, parsing the bitstream to determine the first quantization coefficient of the current coefficient of the current block.

In a tenth clause, according to the ninth clause, where
in a case where the second syntax element information is a first value, it characterizes that there is coefficient coding in the coefficient region where the current coefficient is located; and
in a case where the second syntax element information is a second value, it characterizes that there is no coefficient coding in the coefficient region where the current coefficient is located.

In an eleventh clause, according to the eighth clause, where scanning the current coefficient of the current block, and determining the first quantization coefficient of the current coefficient of the current block based on the second syntax element information of the coefficient region where the current coefficient is located includes:
in a case where the second syntax element information of the coefficient region where the current coefficient is located indicates that there is no coefficient coding in a current coefficient region where the current coefficient is located except a DC coefficient, in response to that the current coefficient is a non-DC coefficient, determining that a first quantization coefficient of the non-DC coefficient is zero, or in response to that the current coefficient is the DC coefficient, parsing the bitstream to determine a first quantization coefficient corresponding to the DC coefficient; or
in a case where the second syntax element information of the coefficient region where the current coefficient is located indicates that there is coefficient coding in the current coefficient region where the current coefficient is located except the DC coefficient, parsing the bitstream to determine the first quantization coefficient of the current coefficient of the current block.

In a twelfth clause, according to the eighth clause, where scanning the current coefficient of the current block, and determining the first quantization coefficient of the current coefficient of the current block based on the second syntax element information of the coefficient region where the current coefficient is located includes:
in a case where the second syntax element information of the coefficient region where the current coefficient is located indicates that there is no coefficient coding in the current coefficient region where the current coefficient is located except a last non-zero coefficient, in response to that the current coefficient is not the last non-zero coefficient, determining that the first quantization coefficient of the current coefficient is zero, or in response to that the current coefficient is the last non-zero coefficient, determining that a first quantization coefficient corresponding to the last non-zero coefficient by parsing the bitstream; and
in a case where the second syntax element information of the coefficient region where the current coefficient is located indicates that there is coefficient coding in the current coefficient region where the current coefficient is located except the last non-zero coefficient, parsing the bitstream to determine the first quantization coefficient of the current coefficient of the current block.

In a thirteenth clause, according to the eleventh clause, where
in a case where second syntax element information of a coefficient region where the DC coefficient is located is a first value, it characterizes that there is coefficient coding in the current coefficient region where the current coefficient is located except the DC coefficient; and
in a case where the second syntax element information of the coefficient region where the DC coefficient is located is a second value, it characterizes that there is no coefficient coding in the current coefficient region where the current coefficient is located except the DC coefficient.

In a fourteenth clause, according to the twelfth clause, where
in a case where second syntax element information of a coefficient region where the last non-zero coefficient is located is a first value, it characterizes that there is coefficient coding in the current coefficient region where the current coefficient is located except the last non-zero coefficient; and
in a case where second syntax element information of a coefficient region where the last non-zero coefficient is located is a second value, it characterizes that there is no coefficient coding in the current coefficient region where the current coefficient is located except the last non-zero coefficient.

In a fifteenth clause, according to the first clause, where
numbers of to-be-decoded coefficients corresponding to the respective coefficient regions are the same or different; and the one or more coefficient regions include non-zero coefficients.

In a sixteenth clause, an encoding method applied to an encoder is provided, which includes:
partitioning a current block according to a scanning order of the current block, to determine at least one coefficient region; where each coefficient region corresponds to multiple to-be-encoded coefficients, and scanning order indexes corresponding to to-be-encoded coefficients in the each coefficient regions are continuous;
determining pieces of second syntax element information of respective coefficient regions; where second syntax element information indicates whether coefficient coding is required to be performed on a coefficient region; and
performing entropy coding on a quantization coefficient of at least one coefficient region based on the pieces of second syntax element information of the respective coefficient regions, to write encoded quantization coefficient into a bitstream.

In a seventeenth clause, according to the sixteenth clause, where determining the pieces of second syntax element information of the respective coefficient regions includes:
in a case where there is a non-zero coefficient in quantization coefficients of a third coefficient region, determining that second syntax element information of the third coefficient region characterizes that coefficient coding is required to be performed on the third coefficient region; where the third coefficient region is any coefficient region of the respective coefficient regions; or
in a case where there is no non-zero coefficient in the quantization coefficients of the third coefficient region, determining that the second syntax element information of the third coefficient region characterizes that coefficient coding is not required to be performed on the third coefficient region; and
performing entropy coding on the quantization coefficient of the at least one coefficient region based on the pieces of second syntax element information of the respective coefficient regions, to write the encoded quantization coefficient into the bitstream includes:
performing entropy coding on the quantization coefficient of the third coefficient region based on the second syntax element information of the third coefficient region, to obtain first encoding information to be written into the bitstream.

In an eighteenth clause, according to the sixteenth clause or the seventeenth clause, where
in a case where the second syntax element information is a first value, it characterizes that coefficient coding is required to be performed on a current coefficient region; and
in a case where the second syntax element information is a second value, it characterizes that coefficient coding is not required to be performed on the current coefficient region.

In a nineteenth clause, according to the sixteenth clause, where determining the pieces of second syntax element information of the respective coefficient regions includes:
in a case where there is a non-zero coefficient in quantization coefficients of a coefficient region where a DC coefficient is located except the DC coefficient, determining that second syntax element information of the coefficient region where the DC coefficient is located characterizes that coefficient coding is required to be performed on a corresponding coefficient region except the DC coefficient; or
in a case where there is no non-zero coefficient in the quantization coefficients of the coefficient region where the DC coefficient is located except the DC coefficient, determining that the second syntax element information of the coefficient region where the DC coefficient is located characterizes that coefficient coding is not required to be performed on the corresponding coefficient region except the DC coefficient; and
performing entropy coding on the quantization coefficient of the at least one coefficient region based on the pieces of second syntax element information of the respective coefficient regions, to write the encoded quantization coefficient into the bitstream includes:
performing entropy coding on the DC coefficient and the non-zero coefficient to obtain second encoding information to be written into the bitstream; or performing entropy coding on the DC coefficient to obtain third encoding information to be written into the bitstream.

In a twentieth clause, according to the nineteenth clause, where
in a case where the second syntax element information of the coefficient region where the DC coefficient is located is a first value, it characterizes that coefficient coding is required to be performed on a current coefficient region where a current coefficient is located except the DC coefficient; and
in a case where the second syntax element information of the coefficient region where the DC coefficient is located is a second value, it characterizes that coefficient coding is not required to be performed on the current coefficient region where the current coefficient is located except the DC coefficient.

In a twenty-first clause, according to the sixteenth clause, where determining the pieces of second syntax element information of the respective coefficient regions includes:
in a case where there is a non-zero coefficient in quantization coefficients of a coefficient region where a last non-zero coefficient is located except the last non-zero coefficient, determining that second syntax element information of the coefficient region where the last non-zero coefficient is located characterizes that coefficient coding is required to be performed on a corresponding coefficient region except the last non-zero coefficient; or
in a case where there is no non-zero coefficient in the quantization coefficients of the coefficient region where the last non-zero coefficient is located except the last non-zero coefficient, determining that the second syntax element information of the coefficient region where the last non-zero coefficient is located characterizes that coefficient coding is not required to be performed on the corresponding coefficient region except the last non-zero coefficient; and
performing entropy coding on the quantization coefficient of the at least one coefficient region based on the pieces of second syntax element information of the respective coefficient regions, to write the encoded quantization coefficient into the bitstream includes:
performing entropy coding on the last non-zero coefficient and other non-zero coefficients to obtain fourth encoding information to be written into the bitstream; or performing entropy coding on the last non-zero coefficient to obtain fifth encoding information to be written into the bitstream.

In a twenty-second clause, according to the twenty-first clause, where
in a case where second syntax element information of the coefficient region where the last non-zero coefficient is located is a first value, it characterizes that coefficient coding is required to be performed on a current coefficient region where a current coefficient is located except the last non-zero coefficient; and
in a case where the second syntax element information of the coefficient region where the last non-zero coefficient is located is a second value, it characterizes that coefficient coding is not required to be performed on the current coefficient region where the current coefficient is located except the last non-zero coefficient.

In a twenty-third clause, according to any one of the sixteenth clause to twenty-second clause, where the method further includes:
writing the second syntax element information into the bitstream.

In a twenty-fourth clause, according to any one of the sixteenth clause to twenty-second clause, where the method further includes:
writing encoding information into the bitstream, where the encoding information includes at least one of: first encoding information, second encoding information, third encoding information, fourth encoding information or fifth encoding information.

In a twenty-fifth clause, according to any one of the sixteenth clause to twenty-second clause, where the method further includes:
determining an end of block of the current block, and writing the end of block as first syntax element information into the bitstream.

In a twenty-sixth clause, according to any one of the sixteenth clause to twenty-second clause, where
numbers of to-be-encoded coefficients corresponding to the respective coefficient region are the same or different; and the at least one coefficient region includes non-zero coefficients.

What is claimed is:

1. A decoding method, applied to a decoder, wherein the method comprises:
parsing a bitstream to determine first syntax element information of a current block;
determining a coefficient region where to-be-decoded coefficients of the current block are located based on an end of block of the current block indicated by the first syntax element information; wherein the coefficient region comprises one or more coefficient regions, and scanning orders of respective coefficient regions are continuous;
determining second syntax element information of the coefficient region; wherein the second syntax element information indicates whether coefficient decoding is required to be performed on the coefficient region; and
determining a quantization coefficient value of the current block based on the second syntax element information.

2. The method according to claim 1, wherein determining the second syntax element information of the coefficient region comprises:
parsing the bitstream to determine the second syntax element information corresponding to the coefficient region.

3. The method according to claim 1, wherein the method further comprises:
partitioning the current block according to a scanning order of the current block, to determine at least one coefficient region; wherein each of the at least one coefficient region corresponds to multiple to-be-decoded coefficients, and scanning order indexes corresponding to the to-be-decoded coefficients in each of the at least one coefficient region are continuous; and
determining a region index of each of the at least one coefficient region according to a region arrangement order.

4. The method according to claim 1, wherein determining the coefficient region where the to-be-decoded coefficients of the current block are located based on the end of block of the current block indicated by the first syntax element information comprises:
determining a first scanning order index where a last non-zero coefficient is located based on the end of block of the current block indicated by the first syntax element information;
determining a first coefficient region to which the first scanning order index belongs based on a correspondence between a scanning order index and a coefficient region; and
in a case where the first coefficient region is not a last scan region, determining a second coefficient region to be scanned after the first coefficient region according to a region arrangement order;
wherein the first coefficient region and the second coefficient region are coefficient regions where the to-be-decoded coefficients of the current block are located.

5. The method according to claim 4, wherein after determining the first coefficient region to which the first scanning order index belongs based on the correspondence between the scanning order index and the coefficient region, the method further comprises:
in a case where the first coefficient region is the last scan region, determining the first coefficient region as the coefficient region where the to-be-decoded coefficients of the current block are located.

6. The method according to claim 1, wherein determining the second syntax element information of the coefficient region comprises:
determining a number of coefficient regions of the coefficient region where the to-be-decoded coefficients of the current block are located; and
determining pieces of second syntax element information of the respective coefficient regions based on the number of coefficient regions.

7. The method according to claim 6, wherein determining the pieces of second syntax element information of the respective coefficient regions based on the number of coefficient regions comprises:
in response to that the number of coefficient regions is less than or equal to 2, determining that the pieces of second syntax element information corresponding to the coefficient regions are all a first value; or
in response to that the number of coefficient regions is greater than 2, determining that second syntax element information of a coefficient region corresponding to a maximum region index and second syntax element information of a coefficient region corresponding to a minimum region index in the coefficient region where the to-be-decoded coefficients are located are both the first value; and determining second syntax element information of a third coefficient region by parsing the bitstream; wherein the third coefficient region is a coefficient region corresponding to other region indexes between the maximum region index and the minimum region index; or
determining that second syntax element information corresponding to a coefficient region where a DC coefficient is located is the first value, and determining pieces of second syntax element information of other coefficient regions by parsing the bitstream; or
determining that second syntax element information corresponding to a coefficient region where a last non-zero coefficient is located is the first value, and determining pieces of second syntax element information of other coefficient regions by parsing the bitstream.

8. The method according to claim 1, wherein determining the quantization coefficient value of the current block based on the second syntax element information comprises:
scanning a current coefficient of the current block, and determining a first quantization coefficient of the current coefficient of the current block based on second syntax element information of a coefficient region where the current coefficient is located; continuing to scan a next coefficient of the current block based on second syntax element information of a coefficient region where the next coefficient of the current block is located in a scanning order until first quantization coefficients of respective coefficients of the current block are determined; wherein a first coefficient of the current block is a coefficient indicated by a scanning order index corresponding to the end of block; and
determining the quantization coefficient value of the current block based on the first quantization coefficients of the respective coefficients.

9. The method according to claim 8, wherein scanning the current coefficient of the current block, and determining the first quantization coefficient of the current coefficient of the current block based on the second syntax element information of the coefficient region where the current coefficient is located comprises:
in a case where the current coefficient of the current block is scanned and the second syntax element information of the coefficient region where the current coefficient is located is a second value, determining that the first quantization coefficient of the current coefficient of the current block is zero; or
in a case where the current coefficient of the current block is scanned and the second syntax element information of the coefficient region where the current coefficient is located is a first value, parsing the bitstream to determine the first quantization coefficient of the current coefficient of the current block.

10. An encoding method, applied to an encoder, wherein the method comprises:
partitioning a current block according to a scanning order of the current block, to determine at least one coefficient region; wherein each coefficient region corresponds to multiple to-be-encoded coefficients, and scanning order indexes corresponding to to-be-encoded coefficients in the each coefficient regions are continuous;
determining pieces of second syntax element information of respective coefficient regions; wherein second syntax element information indicates whether coefficient coding is required to be performed on a coefficient region; and
performing entropy coding on a quantization coefficient of at least one coefficient region based on the pieces of second syntax element information of the respective coefficient regions, to write encoded quantization coefficient into a bitstream.

11. The method according to claim 10, wherein determining the pieces of second syntax element information of the respective coefficient regions comprises:
in a case where there is a non-zero coefficient in quantization coefficients of a third coefficient region, determining that second syntax element information of the third coefficient region is a first value; wherein the third coefficient region is any coefficient region of the respective coefficient regions; or
in a case where there is no non-zero coefficient in the quantization coefficients of the third coefficient region, determining that the second syntax element information of the third coefficient region is a second value; and
performing entropy coding on the quantization coefficient of the at least one coefficient region based on the pieces of second syntax element information of the respective coefficient regions, to write the encoded quantization coefficient into the bitstream comprises:
performing entropy coding on the quantization coefficient of the third coefficient region based on the second syntax element information of the third coefficient region, to obtain first encoding information to be written into the bitstream.

12. A decoder, comprising: a first memory and a first processor; wherein
the first memory is configured to store a computer program executable on the first processor; and
the first processor is configured to invoke the computer program stored in the first memory and run the computer program to perform:
parsing a bitstream to determine first syntax element information of a current block;
determining a coefficient region where to-be-decoded coefficients of the current block are located based on an end of block of the current block indicated by the first syntax element information; wherein the coefficient region comprises one or more coefficient regions, and scanning orders of respective coefficient regions are continuous;
determining second syntax element information of the coefficient region; wherein the second syntax element information indicates whether coefficient decoding is required to be performed on the coefficient region; and
determining a quantization coefficient value of the current block based on the second syntax element information.

13. The decoder according to claim 12, wherein determining the second syntax element information of the coefficient region comprises:
parsing the bitstream to determine the second syntax element information corresponding to the coefficient region.

14. The decoder according to claim 12, wherein the first processor is further configured to invoke the computer program stored in the first memory and run the computer program to perform:
partitioning the current block according to a scanning order of the current block, to determine at least one coefficient region; wherein each of the at least one coefficient region corresponds to multiple to-be-decoded coefficients, and scanning order indexes corresponding to the to-be-decoded coefficients in each of the at least one coefficient region are continuous; and
determining a region index of each of the at least one coefficient region according to a region arrangement order.

15. The decoder according to claim 12, wherein determining the coefficient region where the to-be-decoded coefficients of the current block are located based on the end of block of the current block indicated by the first syntax element information comprises:
determining a first scanning order index where a last non-zero coefficient is located based on the end of block of the current block indicated by the first syntax element information;
determining a first coefficient region to which the first scanning order index belongs based on a correspondence between a scanning order index and a coefficient region; and
in a case where the first coefficient region is not a last scan region, determining a second coefficient region to be scanned after the first coefficient region according to a region arrangement order;
wherein the first coefficient region and the second coefficient region are coefficient regions where the to-be-decoded coefficients of the current block are located.

16. The decoder according to claim 15, wherein after determining the first coefficient region to which the first scanning order index belongs based on the correspondence between the scanning order index and the coefficient region, the method further comprises:
in a case where the first coefficient region is the last scan region, determining the first coefficient region as the coefficient region where the to-be-decoded coefficients of the current block are located.

17. The decoder according to claim 1, wherein determining the second syntax element information of the coefficient region comprises:
determining a number of coefficient regions of the coefficient region where the to-be-decoded coefficients of the current block are located; and
determining pieces of second syntax element information of the respective coefficient regions based on the number of coefficient regions.

18. The decoder according to claim 17, wherein determining the pieces of second syntax element information of the respective coefficient regions based on the number of coefficient regions comprises:
in response to that the number of coefficient regions is less than or equal to 2, determining that the pieces of second syntax element information corresponding to the coefficient regions are all a first value; or
in response to that the number of coefficient regions is greater than 2, determining that second syntax element information of a coefficient region corresponding to a maximum region index and second syntax element information of a coefficient region corresponding to a minimum region index in the coefficient region where the to-be-decoded coefficients are located are both the first value; and determining second syntax element information of a third coefficient region by parsing the bitstream; wherein the third coefficient region is a coefficient region corresponding to other region indexes between the maximum region index and the minimum region index; or
determining that second syntax element information corresponding to a coefficient region where a DC coefficient is located is the first value, and determining pieces of second syntax element information of other coefficient regions by parsing the bitstream; or
determining that second syntax element information corresponding to a coefficient region where a last non-zero coefficient is located is the first value, and determining pieces of second syntax element information of other coefficient regions by parsing the bitstream.

19. The decoder according to claim 12, wherein determining the quantization coefficient value of the current block based on the second syntax element information comprises:
scanning a current coefficient of the current block, and determining a first quantization coefficient of the current coefficient of the current block based on second syntax element information of a coefficient region where the current coefficient is located; continuing to scan a next coefficient of the current block based on second syntax element information of a coefficient region where the next coefficient of the current block is located in a scanning order until first quantization coefficients of respective coefficients of the current block are determined; wherein a first coefficient of the current block is a coefficient indicated by a scanning order index corresponding to the end of block; and
determining the quantization coefficient value of the current block based on the first quantization coefficients of the respective coefficients.

20. The decoder according to claim 19, wherein scanning the current coefficient of the current block, and determining the first quantization coefficient of the current coefficient of the current block based on the second syntax element information of the coefficient region where the current coefficient is located comprises:
in a case where the current coefficient of the current block is scanned and the second syntax element information of the coefficient region where the current coefficient is located is a second value, determining that the first quantization coefficient of the current coefficient of the current block is zero; or
in a case where the current coefficient of the current block is scanned and the second syntax element information of the coefficient region where the current coefficient is located is a first value, parsing the bitstream to determine the first quantization coefficient of the current coefficient of the current block.
